(19) United States
(12) Patent Application Publication
(10) Pub. No.: US 2026/0270117 A1
(43) Pub. Date: Sep. 10, 2026

(54) COMMUNICATION METHOD AND COMMUNICATION APPARATUS

(71) Applicant: Huawei Technologies Co., Ltd., Shenzhen (CN)

(72) Inventors: Yiqun Ge, Ottawa (CA); Nghia Trung Doan, Ottawa (CA); Wuxian Shi, Kanata (CA); Tayebeh Lotfi Mahyari, Ottawa (CA); Xiaoyan Bi, Shanghai (CN); Jianglei Ma, Ottawa (CA)

(21) Appl. No.: 19/667,237

(22) Filed: May 4, 2026

Related U.S. Application Data
(63) Continuation of application No. PCT/CN2024/080863, filed on Mar. 8, 2024.
(60) Provisional application No. 63/596,748, filed on Nov. 7, 2023.

(51) Int. Cl. H04L 25/02; H04L 5/00

(52) U.S. Cl. CPC H04L 25/0224; H04L 5/0044; H04L 5/0094

(57) ABSTRACT

Embodiments of the present application relate to a communication method and communication apparatus. In an example method, a user equipment (UE) may transmit K sets of sounding reference signals corresponding to K sub-channels of an uplink (UL) channel to a base station (BS). K can be a positive integer. The BS may transmit a downlink control information (DCI) corresponding to the K sets of sounding reference signals to the UE. The DCI can include a first information indicating a channel estimation of a first sub-channel among the K sub-channels.

### CROSS-REFERENCE TO RELATED APPLICATIONS

This application is a continuation of International Application No. PCT/CN2024/080863, filed on Mar. 8, 2024, which claims priority to and the benefit of U.S. Provisional Patent Application No. 63/596,748, filed on Nov. 7, 2023, entitled “A Single-User Uplink MIMO with Ultra-low-dimensional Equivalent Latent Space.” The disclosures of the aforementioned applications are hereby incorporated by reference in their entireties.

### TECHNICAL FIELD

Embodiments of the present application relate to the field of communications, and more specifically, to a communication method and a communication apparatus involving channel estimation of uplink channel.

### BACKGROUND

In a wireless communication system, it is important to acquire the characteristics of a channel. In order to estimate a channel, pilot signals known to both transmitting apparatus and receiving apparatus are transmitted. The receiving apparatus can estimate the channel by measuring the pilot signals transmitted by the transmitting apparatus and comparing the measurements with the known transmitted signals.

With the evolution of communication systems, channel bands become wider while the number of antennas or antenna ports keep increasing in communication systems, which increasing the computation resources and communication resources used for channel estimating.

### SUMMARY

Embodiments of the present application provide a communication method and a communication apparatus involving channel estimation of uplink channel. The technical solutions may reduce computation resources and communication resources used for uplink channel estimating.

A first aspect of the disclosure involves a communication method applied at base station (BS) side, comprising: receiving K sets of sounding reference signals corresponding to K sub-channels of uplink (UL) channel, K is a positive integer; transmitting a downlink control information (DCI) based on the K sets of sounding reference signals; wherein, the DCI comprises a first information indicating the channel estimation for a first sub-channel among the K sub-channels.

In some embodiments of the first aspect, the UE may reconstruct the uplink channel based on the DCI. For example, the UE may determine channel estimation of any sub-channel based on the channel estimation of the first sub-channel and a relationship between channel estimation of the first sub-channel and channel estimation of one or more sub-channels within the K sub-channels other than the first sub-channel.

Due to the method involved in the first aspect, the BS may transmit a DCI comprise the first information to instruct user equipment (UE) reconstruct the uplink channel instead of transmitting the channel estimation of all sub-channels to the UE, which may reduce the amount of data transmitting from the BS to the UE during the channel estimation.

One or more embodiments according to the method in the first aspect, wherein: the DCI further comprises a second information indicating a relationship between channel estimation of the first sub-channel and channel estimation of one or more sub-channels within the K sub-channels other than the first sub-channel while K>1.

In those embodiments, the second information may indicates relationship between channel estimation of the first sub-channel and channel estimation of other sub-channels within the K sub-channels other than the first sub-channel.

In those embodiments, the second information may indicates relationship between channel estimation of the first sub-channel and channel estimation of part of sub-channels within the K sub-channels other than the first sub-channel.

In those embodiments, the relationship between channel estimation of the first sub-channel and channel estimation of other sub-channels within the K sub-channels other than the first sub-channel is determined by the BS and transmitted via DCI.

One or more embodiments according to the method in the first aspect, wherein: the K sub-channels are equal-sized.

In those embodiments, the relationship between channel estimation of the first sub-channel and channel estimation of sub-channels within the K sub-channels other than the first sub-channel may be simple due to the K sub-channels are equal-sized, which may reduce the computation resource need for determining the second information by the BS or reconstructing the uplink channel by the UE.

One or more embodiments according to the method in the first aspect, wherein: the K sets of sounding reference signals are respectively corresponding to the K sub-channels, and each set of sounding reference signals are transmitted on the corresponding sub-channel.

One or more embodiments according to the method in the first aspect, wherein: the first information comprises a first channel coefficient vector (yᵢ) of the first sub-channel; the second information comprises a first transformation matrix (G_{y}) or a first transformation information indicating the first transformation matrix, and the first transformation matrix indicates a relationship between the first channel coefficient vector (yᵢ) and the channel coefficient vectors of one or more sub-channels within the K sub-channels other than the first channel coefficient vector (yᵢ).

One or more embodiments according to the method in the first aspect, wherein: yᵢ₊ⱼ=G_{y}^{j}yᵢ, the first sub-channel is the i-th sub-channel in the K sub-channels, yᵢ₊ⱼ refers to the channel coefficient vector of the (i+j)-th sub-channel in the K sub-channels, i and j are integer, 1≤i+j≤K.

One or more embodiments according to the method in the first aspect, wherein the first transformation information comprises one or more matrices determined by decomposing the first transformation matrix.

In those embodiments, the one or more matrices determined by decomposing the first transformation matrix may have smaller data amount than the first transformation matrix itself, which may reduce the communication resource needed for transmitting the first transformation matrix.

One or more embodiments according to the method in the first aspect, wherein: the one or more matrices comprise a first eigenvalue matrix (Ψ_{y}) and a first eigenvector matrix (Λ_{y}); the first eigenvalue matrix (Ψ_{y}) and the first eigenvector matrix (Λ_{y}) are determined by performing Eigen-decomposition on the first transformation matrix (G_{y}).

One or more embodiments according to the method in the first aspect, wherein: the first information comprises a first low-dimension channel coefficient vector (cᵢ) corresponding to a first channel coefficient vector (yᵢ) of the first sub-channel; the second information comprises a second transformation matrix (G_{c}) or a second transformation information indicating the second transformation matrix, and the second transformation matrix indicates a relationship between the first low-dimension channel coefficient vector (cᵢ) and low-dimension channel coefficient vectors corresponding to the channel coefficient vectors of one or more sub-channels within the K sub-channels other than the first low-dimension channel coefficient vector (cᵢ).

In those embodiments, the BS transmits a first low-dimension channel coefficient vector (cᵢ) corresponding to a first channel coefficient vector (yᵢ) of the first sub-channel instead of transmitting the first channel coefficient vector (yᵢ), which may reduce the communication resource needed for transmitting the channel estimation of the first sub-channel because the data amount of the first low-dimension channel coefficient vector (cᵢ) is smaller than the corresponding first channel coefficient vector (yᵢ). Besides, the second transformation matrix (G_{c}) or the second transformation information also has smaller data amount that the aforementioned the first transformation matrix (G_{y}) or the first transformation information, which may further reduce the communication resource needed for channel estimation and reconstructing the uplink channel.

One or more embodiments according to the method in the first aspect, wherein: cᵢ₊ⱼ=G_{c}^{j}cᵢ, the first sub-channel is the i-th sub-channel in the K sub-channels, cᵢ₊ⱼ refers to the low-dimension channel coefficient vector of the (i+j)-th sub-channel in the K sub-channels, 1≤i+j≤K, i and j are integer.

One or more embodiments according to the method in the first aspect, wherein: the second transformation information comprises one or more matrices determined by decomposing the second matrix.

In those embodiments, the one or more matrices determined by decomposing the second transformation matrix may have smaller data amount than the second transformation matrix itself, which may reduce the communication resource needed for transmitting the second transformation matrix.

One or more embodiments according to the method in the first aspect, wherein: the one or more matrices comprises a second eigenvalue matrix (Ψ_{c}) and a second eigenvector matrix (Λ_{c}); the second eigenvalue matrix (Ψ_{c}) and the second eigenvector matrix (Λ_{c}) is determined by performing Eigen-decomposition on the second transformation matrix (G_{c}).

One or more embodiments according to the method in the first aspect, wherein: low-dimension channel coefficient vector of u-th sub-channel in the K sub-channels (cᵤ) is determined by compressing channel coefficient vector of the u-th sub-channel (yᵤ) based on a common basis (U) of the UL channel or a secondary common basis (U_{secondary}) corresponding to a user equipment (UE) cluster, the UE cluster comprises the UE transmitting the K sets of sounding reference signals, u is integer and 1≤u≤K.

One or more embodiments according to the method in the first aspect, wherein: cᵤ=(UP)⁻¹yᵤ, or cᵤ=(U_{secondary}P_{secondary})⁻¹yᵤ, or cᵤ=(UP)^{†}yᵤ, or cᵤ=(U_{secondary}P_{secondary})^{†}yᵤ, P is a low-dimension matrix of U, P_{secondary} is a low-dimension matrix of U_{secondary}, “†” refers to pseudoinverse of a matrix or a vector.

One or more embodiments according to the method in the first aspect, wherein: the P or the P_{secondary} indicates the pattern information corresponding to the K sets of sounding reference signals, wherein the pattern information indicates at least one of the following information of each sounding reference signal in the K sets of sounding reference signals: frequency intervals, time intervals, index of antennas or antenna ports of the BS, index of antennas or antenna ports of the UE, values, antenna port, or transmit power.

One or more embodiments according to the method in the first aspect, wherein the method further comprises: transmitting a compression information to the UE, wherein the compression information indicates one or more of the following information: the common basis (U) and the P; the secondary common basis (U_{secondary}) and the P_{secondary}; the common basis (U) and method for determining the P based on the U; the secondary common basis (U_{secondary}) and method for determining the P_{secondary} based on the U_{secondary}.

One or more embodiments according to the method in the first aspect, wherein the compression information comprises: the common basis (U) and the P; and/or the secondary common basis (U_{secondary}) and the P_{secondary}.

One or more embodiments according to the method in the first aspect, wherein the UL channel comprises M sub-channels, and M is an integer greater than or equal to K.

In those embodiments, the BS may estimate part sub-channels of the uplink channel (that is K<M), which may further reduce the communication resource for transmitting sounding reference signals and computation resource for determining the DCI.

One or more embodiments according to the method in the first aspect, wherein the M sub-channels are determined by dividing the UL channel based on one or more of the following dimensions: frequency domain, time domain, space domain.

One or more embodiments according to the method in the first aspect, wherein there are Q sub-channels between the n-th sub-channel in the K sub-channels and the (n+1)-th sub-channel in the K sub-channels, Q and n are integer, o≤Q≤M/K, 1≤n≤K−1.

In those embodiments, the K sub-channels are non-continues sub-channels, that is, there are Q sub-channels between two adjacent sub-channel in K sub-channels, which may further reduce the communication resource for transmitting sounding reference signals and computation resource for determining the DCI.

One or more embodiments according to the method in the first aspect, wherein the method further comprises: transmitting a third information to a UE transmitting the K sets of sounding reference signals, wherein the third information indicates a relationship between channel estimation of sub-channels in UL channel of each UE in a UE cluster, and the UE cluster comprises the UE.

In those embodiments, the third information may indicating the centrum G (e.g. G_{centrum}, G_{c-centrum}, G_{y-centrum}) mentioned in the description part.

One or more embodiments according to the method in the first aspect, wherein the third comprising a third matrix or a third transformation indicating third transformation matrix; wherein: the third matrix indicating a relationship between channel coefficient vectors of sub-channels of each UE in the UE cluster, or a relationship between low-dimension channel coefficient vectors of sub-channels of each UE in the UE cluster.

In those embodiments, the third matrix may be G_{centrum}, G_{c-centrum}, or G_{y-centrum} mentioned in the description part.

One or more embodiments according to the method in the first aspect, wherein: a first set of sounding reference signals in the K sets of sounding reference signals is the same as a second set of sounding reference signals in the K sets of sounding reference signals; or a first set of sounding reference signals in the K sets of sounding reference signals is different from any other sets of sounding reference signals in the K sets of sounding reference signals.

In those embodiments, the pattern (or pattern information) of sounding reference signals of different sub-channel may be same or different.

A second aspect of the disclosure involves a communication method applied at a user equipment (UE) side, comprising: transmitting K sets of sounding reference signals corresponding to K sub-channels of a uplink (UL) channel, K is a positive integer; receiving a downlink control information (DCI) corresponding to the K sets of sounding reference signals; wherein: the DCI comprises a first information indicating the channel estimation for a first sub-channel among the K sub-channels.

In some embodiments of the second aspect, he UE may reconstruct the uplink channel based on the DCI. For example, the UE may determine channel estimation of any sub-channel based on the channel estimation of the first sub-channel and a relationship between channel estimation of the first sub-channel and channel estimation of one or more sub-channels within the K sub-channels other than the first sub-channel.

Due to the method involved in the second aspect, the BS may transmit a DCI comprise the first information to instruct the UE reconstruct the uplink channel instead of transmitting the channel estimation of all sub-channels to the UE, while the UE may transmit reference signals corresponding to part of sub-channels of the uplink channel instead of transmitting the sounding reference signals corresponding to all sub-channels to the BS, which reduce the amount of data transmitting between the UE and the BS during uplink channel estimation.

One or more embodiments according to the method in the second aspect, wherein the DCI further comprises a second information indicating a relationship between channel estimation of the first sub-channel and channel estimation of one or more sub-channels within the K sub-channels other than the first sub-channel while K>1.

One or more embodiments according to the method in the second aspect, wherein the method further comprising: reconstructing the UL channel based on the DCI.

One or more embodiments according to the method in the second aspect, wherein: the K sub-channels are equal-sized.

One or more embodiments according to the method in the second aspect, wherein: the K sets of sounding reference signals are respectively corresponding to the K sub-channels, and each set of sounding reference signals are transmitted on the corresponding sub-channel.

One or more embodiments according to the method in the second aspect, wherein: the first information comprises a first channel coefficient vector (yᵢ) of the first sub-channel; the second information comprises a first transformation matrix (G_{y}) or a first transformation information indicating the first transformation matrix, and the first transformation matrix indicates a relationship between the first channel coefficient vector (yᵢ) and the channel coefficient vectors of one or more sub-channels within the K sub-channels other than the first channel coefficient vector (yᵢ).

One or more embodiments according to the method in the second aspect, wherein: the reconstructing the UL channel based on the DCI, comprising: determining channel coefficient vectors corresponding to the K sub-channels by yᵢ₊ⱼ=G_{y}^{j}yᵢ or yᵢ₊ⱼ=G_{y-centrum}^{j}yᵢ, wherein the first sub-channel is the i-th sub-channel in the K sub-channels, yᵢ₊ⱼ refers to the channel coefficient vector of the (i+j)-th sub-channel in the K sub-channels, i and j are integer, G_{y-centrum} indicates a relationship between channel coefficient vectors of sub-channels of each UE in a UE cluster, the UE cluster comprise the UE, 1≤i+j≤K.

One or more embodiments according to the method in the second aspect, wherein the first transformation information comprises one or more matrices determined by decomposing the first transformation matrix.

One or more embodiments according to the method in the second aspect, wherein: the one or more matrices comprise a first eigenvalue matrix (Ψ_{y}) and a first eigenvector matrix (Λ_{y}); the first eigenvalue matrix (Ψ_{y}) and the first eigenvector matrix (Λ_{y}) are determined by performing Eigen-decomposition on the first transformation matrix (G_{y}).

One or more embodiments according to the method in the second aspect, wherein: the reconstructing the UL channel based on the DCI, comprising: determining channel coefficient vectors corresponding to the K sub-channels by yᵢ₊ⱼ=yᵢ₊ⱼ=Ψ_{y}Λ_{y}^{j}Ψ_{y}⁻¹yᵢ, wherein the first sub-channel is the i-th sub-channel in the K sub-channels, yᵢ₊ⱼ refers to the channel coefficient vector of the (i+j)-th sub-channel in the K sub-channels, i and j are integer, 1≤i+j≤K.

One or more embodiments according to the method in the second aspect, wherein: the first information comprises a first low-dimension channel coefficient vector (cᵢ) corresponding to a first channel coefficient vector (yᵢ) of the first sub-channel; the second information comprises a second transformation matrix (G_{c}) or a second transformation information indicating the second transformation matrix, and the second transformation matrix indicates a relationship between the second low-dimension channel coefficient vector (cᵢ) and the low-dimension channel coefficient vectors of one or more sub-channels within the K sub-channels other than the second low-dimension channel coefficient vector (cᵢ).

One or more embodiments according to the method in the second aspect, wherein: the reconstructing the UL channel based on the DCI, comprising: determining channel coefficient vectors corresponding to the K sub-channels by yᵢ₊ⱼ=UG_{c}^{j}cᵢ or yᵢ₊ⱼ=U_{secondary}G_{c}^{j}cᵢ or yᵢ₊ⱼ=UG_{c-centrum}^{j}cᵢ or yᵢ₊ⱼ=U_{secondary}G_{c-centrum}^{j}cᵢ, wherein, yᵢ₊ⱼ refers to channel coefficient vector of the (i+j)-th sub-channel in the K sub-channels, U refers to a common basis of the UL channel, U_{secondary} refers to a secondary common basis corresponding a UE cluster, the UE cluster comprises the UE, G_{c-centrum} indicates a relationship between low-dimension channel coefficient vectors of sub-channels of each UE in the UE cluster, i and j are integer, 1≤i+j≤K.

One or more embodiments according to the method in the second aspect, wherein the second transformation information comprises one or more matrices determined by decomposing the second transformation matrix.

One or more embodiments according to the method in the second aspect, wherein: the one or more matrices comprises a second eigenvalue matrix (Ψ_{c}) and a second eigenvector matrix (Λ_{c}); the second eigenvalue matrix (Ψ_{c}) and the second eigenvector matrix (Λ_{c}) is determined by performing Eigen-decomposition on the second transformation matrix.

One or more embodiments according to the method in the second aspect, wherein: the reconstructing the UL channel based on the DCI, comprising: determining channel coefficient vectors corresponding to the K sub-channels by yᵢ₊ⱼ=UΨ_{c}Λ_{c}^{j}Ψ_{c}⁻¹cᵢ or yᵢ₊ⱼ=U_{secondary}Ψ_{c}Λ_{c}^{j}Ψ_{c}⁻¹cᵢ, wherein, yᵢ₊ⱼ refers to channel coefficient vector of the (i+j)-th sub-channel in the K sub-channels, U refers to a common basis of the UL channel, U_{secondary} refers to a secondary common basis corresponding to a UE cluster, the UE cluster comprises the UE, i and j are integer, 1≤i+j≤K.

One or more embodiments according to the method in the second aspect, wherein the method further comprises: the P or the P_{secondary} indicates the pattern information corresponding to the K sets of sounding reference signals, wherein the pattern information indicates at least one of the following information of each sounding reference signal in the K sets of sounding reference signals: frequency intervals, time intervals, index of antennas or antenna ports of base station, index of antennas or antenna ports of the UE, values, antenna port, or transmit power.

One or more embodiments according to the method in the second aspect, wherein the method further comprises: receiving a compression information from the base station that receiving the K sets of sounding reference signals, wherein the compression information indicates one or more of the following information: the common basis (U) and the P; the secondary common basis (U_{secondary}) and the P_{secondary}; the common basis (U) and method for determining the P based on the U; the secondary common basis (U_{secondary}) and method for determining the P_{secondary} based on the U_{secondary}.

One or more embodiments according to the method in the second aspect, wherein the compression information comprises:

the common basis (U) and the P; and/or the secondary common basis (U_{secondary}) and the P_{secondary}.

One or more embodiments according to the method in the second aspect, wherein the compression information comprises: receiving a third information from the base station that receiving the K sets of sounding reference signals, wherein the third information indicates the G_{c-centrum} or the G_{y-centrum}.

One or more embodiments according to the method in the second aspect, wherein the UL channel comprises M sub-channels, M is an integer greater than or equal to K.

One or more embodiments according to the method in the second aspect, wherein the M sub-channels are determined by dividing the UL channel based on one or more of the following parameters: frequency domain, time domain, antennas or antenna ports of base station, or antennas or antenna ports of the UE.

One or more embodiments according to the method in the second aspect, wherein there are Q sub-channels between the n-th sub-channel in the K sub-channels and the (n+1)-th sub-channel in the K sub-channels, Q and n are integer, 0≤Q≤M/K, 1≤n≤K−1.

One or more embodiments according to the method in the second aspect, wherein: a first set of sounding reference signals in the K sets of sounding reference signals is the same as a second set of sounding reference signals in the K sets of sounding reference signals; or a first set of sounding reference signals in the K sets of sounding reference signals is different from any other sets of sounding reference signals in the K sets of sounding reference signals.

A third aspect of the disclosure involves an apparatus, wherein the apparatus comprises a processor, wherein the processor is configured to execute one or more instructions stored in a memory, to enable the apparatus to implement any method the involved in the first aspect and the second aspect.

One or more embodiments of the apparatus in the third aspect, wherein the apparatus comprises the memory.

One or more embodiments of the apparatus in the third aspect, wherein the apparatus comprises a communication interface, configured to input and/or output information.

A fourth aspect of the disclosure involves an apparatus, wherein the apparatus comprises a function or unit to implement any method the involved in the first aspect and the second aspect.

In some embodiments, the apparatus of the third or fourth aspect of the disclosure is a terminal, a base station, a communication module in the terminal or the base station, chip or chipset in the terminal or the base station.

A five aspect of the disclosure involves a communication system, comprising a transmitting apparatus and a receiving apparatus, wherein the transmitting apparatus performs the method according to any one of the first aspect, and the receiving apparatus performs the method according to any one of the second aspect.

A six aspect of the disclosure involves a computer readable storage medium, comprising one or more instructions, wherein when the instructions are run on a computer, the computer performs the method according to any one of the first aspect, or the method according to any one of the second aspect.

A seventh aspect of the disclosure involves a computer program product comprising a non-transitory computer-readable medium storing computer executable instructions to perform the method according to any one of the first aspect, or the method according to any one of the second aspect.

The detail explanation and beneficial effects of the third aspect to the seventh aspect may refer to the first aspect and the second aspect.

### BRIEF DESCRIPTION OF THE DRAWINGS

FIG. 1 illustrates a schematic of a communication system according to some embodiments of the disclosure.

FIG. 2 illustrates an example communication system according to some embodiments of the disclosure.

FIG. 3 illustrates examples of electric device and base station according to some embodiments of the disclosure.

FIG. 4 illustrates a basic module structure of a communication system according to some embodiments of the disclosure.

FIG. 5A illustrates an example ray tracing properties of CmWave according to some embodiments of the disclosure.

FIG. 5B illustrates an example ray tracing properties of MmWave according to some embodiments of the disclosure.

FIG. 6 illustrates an exemplary implementation of T-MIMO according to some embodiments of the disclosure.

FIG. 7 illustrates an example of determine reference signals according to some embodiments of the disclosure.

FIG. 8 illustrates a schematic of a dynamic mode decomposition method according to some embodiments of the disclosure.

FIG. 9A illustrates an example of OFDM symbol according to some embodiments of the disclosure.

FIG. 9B illustrates an example of sub-channel according to some embodiments of the disclosure.

FIG. 10 illustrates an example of periodic SRS signaling diagram in 5G according to some embodiments of the disclosure.

FIG. 11 illustrates an example of aperiodic SRS signaling diagram in 5G according to some embodiments of the disclosure.

FIG. 12 illustrates an example of TMIMO system according to some embodiments of the disclosure.

FIG. 13 illustrates a state machine of 6G-MIMO system according to some embodiments of the disclosure.

FIG. 14A-14D illustrate segmentations of 6G T-MIMO channel based on different dimension according to some embodiments of the disclosure.

FIG. 15 illustrates a sequential diagram a first method for UE notification and scheduling according some embodiments of the disclosure.

FIG. 16 illustrates a sequential diagram a second method for UE notification and scheduling according to some embodiments of the disclosure.

FIG. 17 illustrates a sequential diagram a third method for UE notification and scheduling according to some embodiments of the disclosure.

FIG. 18 illustrates a sequential diagram a fourth method for UE notification and scheduling according to some embodiments of the disclosure.

FIG. 19 illustrates an example procedure of the data sample or collection state according to some embodiments of the disclosure.

FIG. 20 illustrates an example diagram of transmitting U and/or P and or r′ according to some embodiments of the disclosure.

FIG. 21 illustrates an example diagram of the transmission state according to some embodiments of the disclosure.

FIG. 22 illustrates a diagram for procedure between BS and UE without using centrum dynamic mode according to some embodiments of the disclosure.

FIG. 23 illustrates a diagram for procedure between BS and UE using centrum dynamic mode according to some embodiments of the disclosure.

FIG. 24 illustrates a sequential diagram of a method without adopting G_{centrum} according to some embodiments of the disclosure.

FIG. 25 illustrates a sequential diagram of a method adopting G_{centrum} according to some embodiments of the disclosure.

FIG. 26 illustrates a flow diagram of a communication method according to some embodiments of the disclosure.

FIG. 27 illustrates a schematic block diagram of an apparatus according to some embodiments of this disclosure.

### DETAILED DESCRIPTION OF ILLUSTRATIVE EMBODIMENTS

The following describes technical solutions of the present application with reference to the accompanying drawings.

The technical solutions in embodiments of this application may be applied to multiple input multiple-output (MIMO) technology. And the technical solutions in embodiments of this application may be applied to various communication systems, such as a fifth generation (5G) wireless communication system, a new ratio (NR) wireless communication system, a long term evolution (LTE) system, an LTE frequency division duplex (FDD) system, an LTE time division duplex (TDD) system, a wireless local area network (WLAN), a satellite communication system, or other evolving communication systems, such as a sixth generation (6G) wireless communication system.

For ease of understanding the embodiments of this application, communication systems are described below.

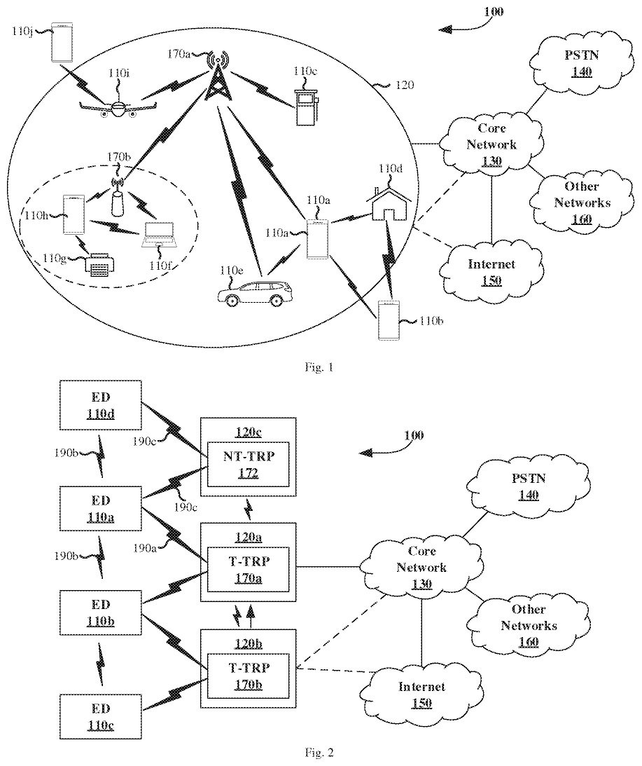

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP), user datagram protocol (UDP). EDs 110a 110b, and 110c may be multimode devices capable of operation according to multiple radio access technologies, and incorporate multiple transceivers necessary to support such.

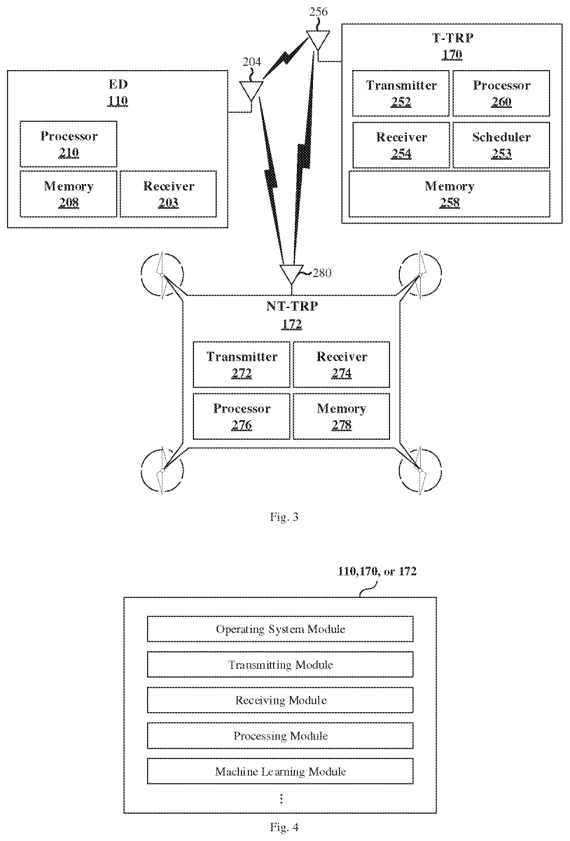

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

In some embodiments, UE is also called user terminal, ED, terminal, transmit apparatus (when transmitting signal), receive apparatus (when receiving signal), etc.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

In some embodiments, BS is also refers to gNB, STA, transmit apparatus, receiver apparatus, etc.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a node B, an evolved nodeB (eNodeB or eNB), a home eNodeB, a next generation nodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

MIMO technology allows an antenna array of multiple antennas to perform signal transmissions and receptions to meet high transmission rate requirement. The above ED 110 and T-TRP 170, and/or NT-TRP use MIMO to communicate over the wireless resource blocks. MIMO utilizes multiple antennas at the transmit apparatus and/or receive apparatus to transmit wireless resource blocks over parallel wireless signals. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the above T-TRP 170, and/or NT-TRP 172 configured with a large number of antennas has gained wide attentions from the academia and the industry. In the large-scale MIMO system, the T-TRP 170, and/or NT-TRP 172 is generally configured with more than ten antenna units (such as 128 or 256), and serves for dozens of the ED 110 (such as 40) in the meanwhile. A large number of antenna units of the T-TRP 170, and NT-TRP 172 can greatly increase the degree of spatial freedom of wireless communication, greatly improve the transmission rate, spectrum efficiency and power efficiency, and eliminate the interference between cells to a large extent. The increase of the number of antennas makes each antenna unit be made in a smaller size with a lower cost. Using the degree of spatial freedom provided by the large-scale antenna units, the T-TRP 170, and NT-TRP 172 of each cell can communicate with many ED 110 in the cell on the same time-frequency resource at the same time, thus greatly increasing the spectrum efficiency. A large number of antenna units of the T-TRP 170, and/or NT-TRP 172 also enable each user to have better spatial directivity for uplink and downlink transmission, so that the transmitting power of the T-TRP 170, and/or NT-TRP 172 and an ED 110 is obviously reduced, and the power efficiency is greatly increased. When the antenna number of the T-TRP 170, and/or NT-TRP 172 is sufficiently large, random channels between each ED 110 and the T-TRP 170, and/or NT-TRP 172 can approach to be orthogonal, and the interference between the cell and the users and the effect of noises can be eliminated. The plurality of advantages described above enable the large-scale MIMO to have a magnificent application prospect.

A MIMO system may include a receiver connected to a receive (Rx) antenna, a transmitter connected to transmit (Tx) antenna, and a signal processor connected to the transmitter and the receiver. Each of the Rx antenna and the Tx antenna may include a plurality of antennas. For instance, the Rx antenna may have an ULA antenna array in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include:

Panel: unit of antenna group, or antenna array, or antenna sub-array which can control its Tx or Rx beam independently.

Beam: A beam is formed by performing amplitude and/or phase weighting on data transmitted or received by at least one antenna port, or may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. The beam information may be a beam identifier, or antenna port(s) identifier, or channel state information reference signal (CSI-RS) resource identifier, or SSB resource identifier, or sounding reference signal (SRS) resource identifier, or other reference signal resource identifier.

MIMO technology represents an advanced wireless communication technique employing multiple antennas at both the transmitter and receiver ends, thereby enhancing the overall efficiency and performance of the radio link. The acronym MIMO stands for multiple-input multiple-output, signifying its capacity to capitalize on the multipath propagation of radio waves, facilitating the simultaneous transmission and reception of multiple data signals. Notably, MIMO technology finds extensive application in contemporary wireless standards such as wireless fidelity (Wi-Fi), worldwide interoperability for microwave access (WiMAX), long term evolution (LTE), and 5G, underscoring its vital role in enabling high-speed and reliable wireless communication.

5G-NR massive MIMO technology represents a groundbreaking advancement in the realm of wireless communication, characterized by its integration of an extensive array of antennas at both the transmitting and receiving ends. This innovative approach enables the simultaneous transmission and reception of multiple data streams, significantly enhancing the overall data throughput and network capacity. By capitalizing on the multipath propagation of radio waves, 5G-NR massive MIMO technology ensures efficient and reliable data transfer, fostering seamless connectivity and improved spectral efficiency. Leveraging this technology, 5G-NR facilitates the deployment of high-speed and low-latency communication networks, catering to the burgeoning demand for enhanced mobile broadband services and supporting diverse applications such as virtual reality, augmented reality, and the internet of things (IoT).

However, certain limitations accompany 5G NR massive MIMO technology. Factors such as an increase in system complexity, directly correlated to the escalated number of antennas in both the 5G base station (e.g. gNB) and UE, may result in heightened energy consumption and infrastructure costs, potentially posing challenges to its widespread implementation. Additionally, the deployment of massive MIMO systems may encounter obstacles related to interference management and spatial constraints, necessitating careful planning and optimization to mitigate potential performance degradation. Despite these challenges, the numerous benefits offered by 5G NR massive MIMO technology continue to position it as a promising solution for next-generation wireless communication networks.

One fundamental characteristic of 6G technology pertains to the significant escalation in the count of antenna ports within the base station or gNB. This notable enhancement facilitates a heightened degree of beamforming and spatial multiplexing, effectively bolstering the spectral efficiency and overall network capacity by separating space with a finer resolution. For instance, the integration of a substantial number of antenna ports in the antenna panel necessitates an operational frequency range for 6G spanning from 10 GHz to 14 GHz. Notably, this frequency range corresponds to a wavelength of approximately one centimeter, commonly referred to as the centimeter (Cm) wave (CmWave) band. The utilization of the CmWave band in 6G technology offers reduced attenuation and diminished interference compared to the millimeter (Mm) wave (MmWave) band utilized by its predecessor, 5G, thereby fostering improved data transmission capabilities and robust network performance.

The utilization of the 10 GHz to 14 GHz frequency band within the MIMO system of 6G technology offers a host of notable advantages. Firstly, the adoption of this frequency band, corresponding to the CmWave range, enables the implementation of a larger number of antenna ports within the base station, facilitating advanced beamforming and spatial multiplexing techniques. This, in turn, leads to enhanced spectral efficiency, allowing for the seamless transmission of a higher volume of data with increased reliability and reduced signal interference. Moreover, the characteristics of the CmWave band, characterized by lower attenuation and reduced susceptibility to environmental obstacles, contribute to the establishment of robust and reliable wireless communication networks. The reduced signal attenuation ensures improved signal propagation over extended distances, thereby fostering the development of more efficient and resilient communication infrastructures within the 6G MIMO system.

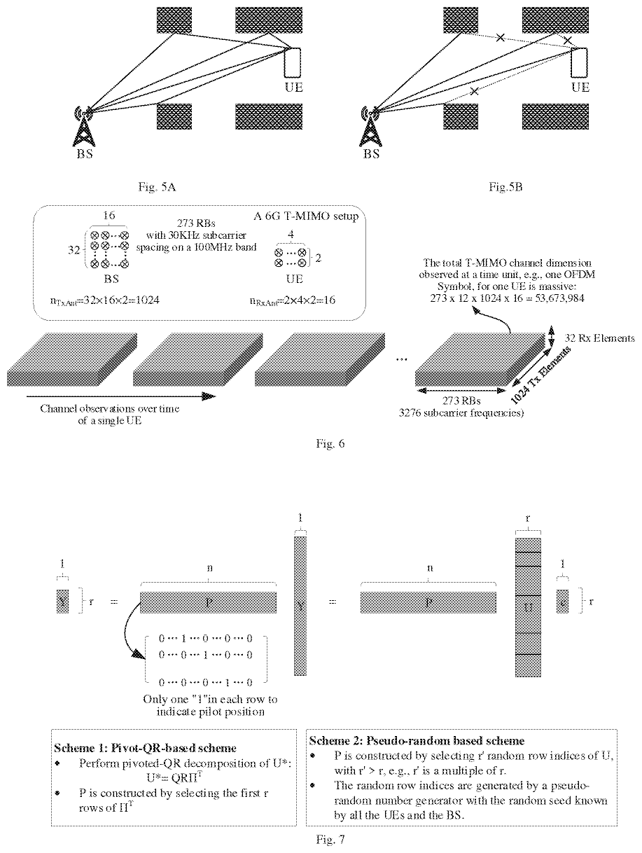

For example, as shown in FIG. 5A and FIG. 5B, the ray tracing properties of CmWave and MmWave is different. Obstacles can reflect CmWave emitted by a transmit apparatus, allowing the receive apparatus to get the information even if there is no direct line of sight that is, non-light-of-sight, (NLoS). However, MmWave require a clear path between the transmit apparatus and the receive apparatus, that is, light-of-sight (LOS) to transmit the information effectively.

Here is some analysis of technical problem and challenge of deploying an ultra large scale MIMO system. As shown in FIG. 6: An exemplary implementation of Tera-bit-per-second MIMO (T-MIMO) within the 6G network, characterized by a base station equipped with up to 1024 antenna ports and user terminals featuring 16 antenna ports across a 500 MHz bandwidth, introduces several noteworthy challenges. Primarily, from a performance perspective, the increased complexity associated with managing a substantial number of antenna ports and bandwidths necessitates system optimization to mitigate potential signal interference and ensure seamless data transmission. Additionally, the significant costs involved in the manufacturing, deployment, and maintenance of a sophisticated network architecture with a high volume of antenna ports and wide bandwidth pose a considerable economic challenge, requiring careful cost-benefit analysis to ensure the viability and sustainability of the 6G MIMO infrastructure. In the following, we will call the MIMO system with a large number of antenna ports as ultra-large-scale MIMO or extreme-large-scale MIMO system.

Furthermore, the heightened complexity of the ultra large scale MIMO system, attributed to the management and coordination of a large number of antenna ports, may result in increased operational intricacies, necessitating advanced signal processing and control mechanisms and more overhead to facilitate efficient data handling and minimize performance bottlenecks. This increased overhead, in terms of both computational resources, radio resources, and energy consumption, demands the implementation of robust overhead management strategies to optimize the overall system performance. Moreover, the augmented radio overhead, including the allocation of resources for pilots (reference signals), control messages, and channel feedback (e.g. channel state information (CSI)), presents a significant challenge in the effective utilization of the available bandwidth. The need for efficient management and allocation of these additional resources requires the implementation of sophisticated air interface protocols and communication strategies, ensuring the optimized utilization of the spectrum and minimizing potential signal degradation. Addressing these challenges necessitates the development of comprehensive and adaptive approaches to enhance the overall efficiency and reliability of the 6G T-MIMO system.

In some embodiments, the pilot may also refer to reference signal, pilots signal, etc.

In some embodiments, the channel feedback may also refer to CSI.

In order to understand our disclosed method, we have to introduce the concept of ray-tracing-based channel model. In the realm of wireless communication, a MIMO channel represents a sophisticated radio channel architecture that leverages the use of multiple antenna ports at both the transmit apparatus and receive apparatus to enhance the efficiency and dependability of data transmission. A radio channel, serving as the conduit for radio waves between a transmit apparatus's antenna port and a receive apparatus's antenna port, manifests at specific spatial locations through intricate interactions with the environment. These interactions include diverse phenomena such as reflection, diffraction, scattering, and fading, ultimately influencing the characteristics of the radio channel. The intricate dynamics of a radio channel at a given spatial location are contingent upon various factors, including the frequency, bandwidth, polarization, phase, and power of the radio waves, as well as the distance, angle, and geometric configuration of the transmit apparatus's and receive apparatus's antennas, alongside the unique attributes of the surrounding structures and mediums. Hence, the dynamics of a MIMO radio channel at a specific spatial point arise from the intricate interplay between the wireless communication environment and its encompassing elements. This encompasses both stationary constituents, such as buildings, terrain contours, and surface materials, as well as dynamic variables like weather conditions, moving trucks, and interference due to surrounding random events. To explicate, analyze, and simulate the characteristics of a MIMO radio channel at a given spatial location, the technique of ray tracing proves instrumental. Ray tracing simulates the propagation and interaction of electromagnetic waves within the environment. In this context, ray tracing enables the modeling of signal behaviors, encompassing reflection, refraction, scattering, and diffraction from various objects and surfaces. The manifestation of a MIMO radio channel stems from two distinct forms of ray tracing: random rays, emitted unpredictably from the transmit apparatus and receive apparatus, and deterministic rays, contingent upon the geometric attributes of the stationary environment.

The document 3rd generation partnership project (3GPP) 38.901 serves as a comprehensive guide outlining the specifications for channel modeling within the frequency range of 0.5 to 100 GHz. It delineates various scenarios, environments, propagation conditions, antenna configurations, and associated parameters essential for accurate channel modeling. Furthermore, the document delineates the systematic approach to creating clusters of radio rays through the amalgamation of stochastic channel modeling and ray tracing techniques. Notably, while the 3GPP 38.901 document primarily emphasizes the stochastic channel model, it acknowledges the optional utilization of the ray tracing model. The stochastic model relies on statistical parameters encompassing path loss, delay spread, angle spread, and more to characterize the propagation environment. In contrast, the ray tracing model operates based on the physical geometry of the surroundings, encompassing structures such as buildings, walls, and vegetation. Although the ray tracing model offers a more comprehensive representation of channel intricacies, including details and variations, it imposes greater computational demands and necessitates extensive input data. Conversely, the stochastic model faces certain limitations, notably its inability to account for blockage or shadowing effects induced by obstacles, thereby impacting signal quality and coverage. Moreover, the stochastic model falls short in capturing the spatial correlation of the channel, which holds critical significance for beamforming and spatial multiplexing (by precoding matrix) in massive MIMO techniques. Consequently, the ray tracing model emerges as a more favorable approach for 6G channel modeling, particularly in the context of high-frequency bands, such as those exceeding 6 GHz, and dense urban scenarios. The analysis underscores the nuanced advantages and trade-offs associated with leveraging random clusters in the context of wireless channel modeling, further highlighting the significance of an integrated approach to accurately represent the deterministic intricacies of the wireless communication environment.

Now we will analyze the dimensionality disaster in an ultra-large-scale MIMO system.

Upon achieving a significant scale, wherein the MIMO integrates an extensive array of more than one thousand antenna ports operating across a bandwidth of up to 500 MHz, the operational overhead associated with the implementation primarily emanates from the essential requisites for CSI estimation and alignment across both UEs and base stations. This crucial process necessitates the transmission and reception of a considerable number of pilot signals, thereby leading to substantial consumption of both bandwidth and power resources. Furthermore, the comprehensive feedback loop for channel estimation adds to the existing signaling overhead, emphasizing the intricate demands of the operational framework.

The integration of such a ultra-large-scale MIMO system entails significant storage demands, operational complexities, and latency considerations. The requisite storage capacity is primarily directed towards accommodating the comprehensive storage requirements for precise CSI, as well as the intricate beamforming and precoding matrices for every UE and base station within the system architecture. This necessitates a storage allocation of approximately terabytes (TB)-order, emphasizing the substantial storage demands associated with the intricate data sets and matrix computations integral to the operational framework.

A comprehensive strategic approach aimed at addressing these storage, complexity, and latency concerns is imperative to ensure the seamless integration and optimal performance of the 6G T-MIMO architecture within the broader 6G wireless communication landscape. Leveraging advanced storage solutions, optimized computational algorithms, and latency reduction strategies are pivotal in ensuring the efficient and streamlined operation of the intricate 6G T-MIMO system architecture within the evolving realm of wireless communication systems.

Therefore, the ultra-large-scale MIMO needs an effective method to reduce the dimensionality. The concept of massive dimension space pertains to a mathematical representation characterized by an extensive number of dimensions, ranging from infinite to uncountable. In contrast, dimensional reduction techniques serve to alleviate the complexities associated with such expansive spaces by projecting them onto lower-dimensional subspaces, often finite or countable in nature. These techniques find utility in diverse applications, spanning data analysis, equation resolution, and structural visualization within the realms of science and engineering. Nonetheless, dimensional reduction strategies are not without trade-offs, with potential compromises encompassing information loss, distortions in distances, and the potential introduction of noise. Consequently, the judicious selection of an appropriate dimensional reduction method and criterion assumes critical significance, underscoring its pivotal role in various scientific and engineering domains.

For instance, envision a bookshelf housing an infinite array of books, each comprising an infinite number of pages. Such an arrangement epitomizes a massive dimension space, wherein each book or page represents a distinct dimension. By applying dimensional reduction to this scenario, one could select a limited subset of relevant books or pages tailored to a specific purpose, such as studying a particular topic or discerning underlying patterns. This selective approach yields a lower-dimensional subspace, where each book or page remains a dimension, albeit in a reduced quantity. However, it is imperative to acknowledge the potential compromises associated with dimensional reduction, including the aforementioned loss of information, distortions in distances, and the introduction of noise, thereby emphasizing the nuanced decision-making process involved in choosing suitable dimensional reduction methods and criteria across diverse scientific and engineering disciplines.

Several notable methods employed for dimensional reduction include:

Principal component analysis (PCA): This technique facilitates a linear mapping of the data to a lower-dimensional space, optimizing the variance of the data within the low-dimensional representation.

Kernel PCA: Employing the kernel trick, this approach enables nonlinear PCA, enhancing its capability to capture intricate and complex data patterns.

Graph-based kernel PCA: This method amalgamates graph theory and kernel techniques, facilitating PCA on datasets situated on nonlinear manifolds.

Singular value decomposition (SVD): SVD serves to factorize a matrix into three distinct matrices, thereby enabling noise reduction, data compression, and the extraction of latent factors from the data.

Some of the methods above derive from eigen-decomposition, which is the factorization of a matrix into its eigenvalues and eigenvectors. Eigenvalues are the scalars that satisfy the equation Aν=λν, where A is the matrix, ν is the eigenvector, and λ is the eigenvalue. Eigenvectors are the vectors that are only scaled by A, not rotated or distorted. By finding the eigenvalues and eigenvectors of a matrix, we can decompose it into a diagonal matrix of eigenvalues and a matrix of eigenvectors. This allows us to identify the principal components of the data, which are the directions of maximum variance. By projecting the data onto a subset of principal components, we can reduce its dimensionality while retaining most of its information.

For example, suppose we have a dataset of n points in d dimensions, represented by an n×d matrix X. We can compute the sample covariance matrix of X as S=(1/n)X^{H}X, which is a d×d symmetric matrix. Then, we can find the eigenvalues and eigenvectors of S using a numerical method such as power iteration or QR algorithm. The eigenvalues of S are non-negative and represent the variance of the data along each principal component. The eigenvectors of S are orthogonal and form a basis for the data space. We can sort the eigenvalues in descending order and select the k largest ones, along with their corresponding eigenvectors. These k eigenvalues and eigenvectors form the k principal components of the data. We can then project X onto these k principal components by multiplying X with a d×k matrix Q, whose columns are the k eigenvectors. The result is an n×k matrix Y, which is a lower-dimensional representation of X that captures most of its variance. The d×k matrix Q, whose columns are the k eigenvectors, contains the most important (principal) commonality between the dataset of the n points.

In some embodiments, QR algorithm refers to orthogonal triangular decomposition algorithm.

Deep learning-based dimensional reduction encounters significant challenges when applied to the extensive dimensional signal space characteristic of T-MIMO communication system (e.g. 6G T-MIMO). As the system involves a vast number of antennas, such as 1024 at the base station and 16 at the terminals, and operates across a bandwidth of 500 MHz, the deep learning models grapple with the tremendous complexity and computational requirements associated with processing such large-scale data. This complexity is compounded by the need for extensive training data to effectively capture the intricacies of the high-dimensional signal space. Furthermore, the high computational demands strain the hardware resources, leading to increased latency and processing times. Despite its capacity to handle complex patterns, the deep learning approach faces substantial limitations in terms of scalability and interpretability, hindering its efficacy in efficiently reducing the dimensions of the expansive T-MIMO communication system (e.g. 6G T-MIMO) signal space.

One of the challenges of 6G communication is to efficiently estimate the massive CSI in both uplink (UL) and downlink (DL) scenarios. A common approach is to use uniform reference signal (pilots) patterns, where the transmit apparatus sends a fixed number of pilot symbols in each coherence interval in each coherence frequency interval (for example, RB in 5G NR). However, this method may not be optimal for 6G T-MIMO, as it requires a large amount of pilot overhead and may not capture the spatial diversity of the channel.

We proposed a novel method for estimating the ultra-large-scale MIMO (e.g. T-MIMO) channel using a sparse and non-uniform pilot pattern, instead of the conventional uniform pattern, for UL. Our method exploits the fact that the MIMO radio channels can be modeled by ray tracing, which implies some similarity among the channels at different spatial locations. This similarity allows us to reduce the dimensionality of the problem and optimize the pilot placement scheme for ultra-large-scale MIMO channel estimation or acquisition. However, we also acknowledge that there are some random factors in the ray propagation, such as the formation of random ray clusters. Therefore, we still need a small number (sparse) of pilots to capture these random effects in the ultra-large-scale MIMO channel.

Reference signal (pilot) placement is a method for selecting optimal locations for reference signals in high-dimensional MIMO channel. The goal is to use a small number of reference signals to capture the most relevant information from the MIMO channel and reconstruct the full state using a low-dimensional representation. QR-based reference-signal placement relies on two main steps: feature extraction and reference-signal selection.

Feature extraction is the process of finding a suitable basis for representing the MIMO channel state using a set of features that capture the dominant patterns or modes of variation in the data. One common way to do this is to apply SVD or proper orthogonal decomposition (POD) to find the eigen vectors of the channel data matrix A contributed by all UEs. The resulting eigen vectors correspond to the principal directions of variation of matrix A and can be ordered by their corresponding singular values or eigen values, which measure the amount of variance explained by each vector. By truncating the eigen vector matrix to retain only the most significant vectors, one can obtain a low-rank approximation of the data matrix A, that preserves most of the information and is called as common basis U.

Reference signal selection is the process of choosing a subset of candidate reference signal locations that maximize the information content or variance captured by the reference signals for all UEs.

In some embodiments, as shown in FIG. 7, the reference signal may be determined by a QR decomposition method (also refer to scheme 1) with column pivoting or pseudo-random placement strategy (also refer to scheme 2).

As shown in FIG. 7:

One efficient way to do this is to use the QR decomposition with column pivoting, which is a matrix factorization technique that produces an orthogonal matrix Q and an upper triangular matrix R such that U*=QRΠ^{T}, where U is the low-rank approximation or common basis of the data matrix in the feature extraction, II is a permutation matrix, specifically a column-pivoting matrix of U*. The column pivoting algorithm selects the columns of U\hat{ }* that have the largest L2 norms and moves them to the left of U*. Let P be a row-pivoting matrix of U constructed by selecting the first r rows of Π^{T}, where r is the rank of U. Let θ be a row-pivoted matrix of U, defined as θ=PU. The permutation matrix P can be used to identify the reference-signal locations that correspond to the selected rows of U. The QR-based reference-signal selection algorithm can be applied to the eigen vector matrix obtained from feature extraction to find the optimal reference-signal locations for reconstructing the channel state using a low-dimensional representation.

QR-based reference-signal placement has several advantages over other methods, such as random sampling or compressed sensing. It is data-driven, meaning that it adapts to the specific patterns and dynamics of the MIMO channel. It is computationally efficient, requiring only two ubiquitous matrix operations: SVD and QR decomposition. It is robust to noise and outliers, as it selects reference-signals based on their variance rather than their magnitude. It also provides a natural way to determine the number of reference-signals needed, as it depends on the rank of the data matrix or the eigen vector matrix.

Apparently, the number of reference-signals is determined by the size of matrix U, which in turn is determined by the number of the most significant vectors after truncated SVD on the collected data set. In general, if there is higher similarity among the MIMO data samples (for SVD), the smaller number of the most significant vectors after truncated SVD, and the less reference-signals are needed (sparser).

Moreover, in a DL MIMO channel, the base station (or gNB) has a large number of antenna ports compared to the UE. This creates an over-determined problem, where the number of equations is greater than the number of unknowns. In such a scenario, the gNB can exploit the spatial diversity and multiplexing gains of the MIMO channel to improve the data rate and reliability of the DL transmission. The gNB can also use beamforming techniques to focus the signal energy towards the desired UE and reduce the interference to other users. In ultra-large-scale MIMO such as 6G T-MIMO, the numbers of antenna ports between gNB is expected to be much larger than in 5G NR, reaching hundreds or thousands of antennas per gNB. This will enable ultra-high data rates, ultra-low latency, and ultra-reliable communication for 6G applications. Thus, the permuted matrix θ=PU is no longer a square matrix representing a determined problem but a rectangular matrix representing an over-determined one. Then, we can benefit from the spatial diversity and multiplexing gains of the MIMO channel by using a pseudo-random permutation matrix P rather than a QR-generated one in DL MIMO channel.

In some embodiments, the matrix U is called as common basis and the matrix O is called as compact matrix of the common basis (matrix) U in terms of the reference signal placement matrix P.

In some embodiments, pseudo-random placement strategy (scheme 2) means the BS may randomly select r′ rows of U to construct the permutation matrix P.

In some embodiments, a pseudo-random permutation matrix P whose size matches with the similarity among the channel data samples collected within a targeted environment can be achieved.

For example, instead of sending a sequence of reference signal positions to indicate the reference signal placement matrix P, the BS can simply sends a random seed, a random generator function, and number of the reference signals. After receiving them, a UE can compute out the reference signal placement matrix P. This would significantly reduce the air overhead, especially in a massive dimensional system of ultra-large-scale MIMO like 6G-T-MIMO.

In this disclosure, we will introduce a new technology called as DMD (dynamic mode decomposition). DMD is a data-driven technique for extracting spatiotemporal coherent structures from high-dimensional data. It can be used to analyze complex nonlinear dynamical systems, such as fluid flows, combustion, neuroscience, and epidemiology. DMD is based on the idea of decomposing a data matrix into a low-rank approximation that captures the dominant modes and frequencies of the underlying dynamics. DMD can also provide a linear model that approximates the nonlinear evolution of the system, which can be used for prediction, control, and optimization.

In some embodiments, extracting spatiotemporal coherent structures from high-dimensional data are also called as dominant modes and frequencies.

DMD is a technique that can help us understand complex systems that change over time and space, such as the flow of air around a wing, the spread of a disease, or the activity of neurons in the brain. DMD works by taking snapshots of the system at different times and arranging them into a matrix. Then, it finds a simpler matrix that is close to the original one, but has fewer rows and columns. This simpler matrix contains the main patterns and rhythms of the system, which are called modes and frequencies. DMD also gives us a formula that tells us how these modes and frequencies change over time, which can help us predict, control, or optimize the system.

One example of using DMD is to analyze the wake behind a cylinder in a fluid flow. This is a classic problem in fluid mechanics, where the flow becomes unstable and forms a periodic pattern of vortices, called a von Karman vortex street. By applying DMD to the snapshots of the flow field, we can identify the modes that correspond to the vortices and their frequencies. We can also use the formula given by DMD to predict how the flow will evolve in the future, or how it will change if we modify the cylinder shape or size.

DMD is closely related to the Koopman operator, which is an infinite-dimensional linear operator that acts on the space of observables of a nonlinear system. The Koopman operator can capture the global behavior of the system by mapping each observable to its future value at a given time. DMD approximates the Koopman operator by projecting the observables onto a finite-dimensional subspace spanned by snapshots of the system state. The resulting matrix can be diagonalized to obtain the DMD modes, which are eigenfunctions of the Koopman operator, and the DMD eigenvalues, which are the corresponding eigenvalues. The DMD modes and eigenvalues can reveal the dominant frequencies, growth rates, spatial patterns and nonlinear interactions of the system.

There may be different types of DMD algorithms. In some embodiments, as shown in FIG. 8, the basic steps of a generic DMD algorithm are:

Data snapshot matrix construction: create two data snapshot matrices, X and X′, by assembling the data snapshots at subsequent time steps. Denote G a linear operator that satisfies X′=GX or equivalently G=X′X^{†}, where X^{†} is the Moore-Penrose pseudoinverse of X.

Perform SVD on X: decompose X=UΣV^{H}, where U and V are orthogonal matrices and > is a diagonal matrix of singular values.

Low-Rank truncation: reduce the rank of the matrices U, E, and V to retain the most significant modes while discarding negligible components.

DMD modes computation:
4.1. Compute the projection of G on to the column space of U^{H} as \tilde{G}=U^{H}GU=U^{H}X′VΣ⁻¹.
4.2. Compute the eigen-decomposition of \tilde{G} as \tilde{G}\tilde{V}=\tilde{V}Λ to obtain the eigenvectors \tilde{V} and eigenvalues Λ of \tilde{G}. \tilde{G} and G share the same eigenvalues A.
4.3. Compute the eigenvectors of G as Ψ=U\tilde{V}. The eigen-decomposition of G is then given by GΨ=ΨΛ.
4.4. Compute the linear operator G based on the pair (Ψ, Λ) as G=ΨΛΨ⁻¹. Together, the pair (Ψ, Λ) represents the DMD of the data X and X′.

Through these computations, DMD effectively captures the underlying spatiotemporal dynamics of the system, making it a valuable tool for identifying coherent structures and analyzing the evolution of complex datasets. The DMD algorithm can be modified or extended in various ways to improve its performance or applicability. For example, one can use different norms or metrics to measure the distance between X and X′, or use different basis functions to project the data on to a lower-dimensional space. One can also incorporate weighting factors to account for time-varying systems or non-uniform sampling rates.

In some embodiments, the linear operator G can be understood as linear transformation matrix that indicates a relationship how to change X to X′.

### Clustering Technology

Clustering technology is a fundamental tool in data analysis and machine learning, aiming to group data points or objects based on similarity or proximity in a multidimensional space. The objective is to minimize intra-cluster variance while maximizing inter-cluster variance. In the context of wireless communication and particularly MIMO technology, clustering can be employed to manage the vast amount of data and the complex interactions among numerous system elements efficiently. For 6G T-MIMO systems, clustering technologies could be instrumental in handling the vast antenna arrays and facilitating efficient signal processing. Here are brief introductions to several clustering methods along with their advantages and disadvantages:

| Method | Principle | Advantages | Disadvantages |
|---|---|---|---|
| K-means | Segregates data into ‘K’ | Simplicity and efficiency in | Assumes clusters to be |
| Clustering | number of clusters. It | processing large datasets. | spherical and equally |
| | minimizes the variance | Easy to implement and | sized, which may not |
| | within each cluster and | interpret. | always be the case. |
| | maximizes the | Scalable to handle more | The number of clusters |
| | variance between | data points as the dataset | ‘K’ needs to be specified |
| | different clusters by | grows. | beforehand, which may |
| | iteratively adjusting | | not be intuitive. |
| | the cluster centroids. | | Sensitive to the initial |
| | | | placement of centroids. |
| Hierarchical | Creates a tree of | Does not require the | Generally, more |
| Clustering | clusters without | number of clusters to be | computationally |
| | requiring the number | specified. | intensive than K-means. |
| | of clusters to be | Provides a dendrogram, a | Not scalable for very |
| | specified a priori. It | visual representation to | large datasets. |
| | can be agglomerative | help understand the data | |
| | (bottom-up) or divisive | structure. | |
| | (top-down). | | |
| DBSCAN | Clusters data based on | Does not require the | May struggle with |
| (Density- | the density of data | number of clusters to be | clusters of varying |
| Based Spatial | points, forming | specified. | densities. |
| Clustering of | clusters of high density | Can discover clusters of | Not efficient with high- |
| Applications | separated by areas of | arbitrary shape. | dimensional data. |
| with Noise) | low density | | |
| Mean Shift | Locates the centroids | Does not assume any prior | Computationally more |
| Clustering | of clusters by shifting | knowledge on the number | intensive. |
| | points towards the | of clusters. | May not be suitable for |
| | densest region in their | Can discover clusters of | high-dimensional spaces. |
| | vicinity. | arbitrary shape. | |
| Spectral | Computes the | Capability to Identify | Computational |
| Clustering | Laplacian of this graph | Complex Cluster Shapes: | Complexity: Spectral |
| | and finds its | Unlike K-means, spectral | clustering can be |
| | eigenvectors. The | clustering can identify | computationally more |
| | eigenvectors | clusters with non-convex | intensive, especially for |
| | corresponding to the | shapes. This is particularly | very large datasets, due |
| | smallest non-zero | useful in scenarios where | to the eigen- |
| | eigenvalues are used to | data clusters are not | decomposition step. |
| | define a low- | spherical or elliptical. | Difficulty in Selecting |
| | dimensional | Reduced Dimensionality: | Optimal Parameters: The |
| | embedding, where the | By transforming the data | effectiveness of spectral |
| | clustering problem is | into a lower-dimensional | clustering can be |
| | easier to solve. Finally, | space, spectral clustering | sensitive to the choice of |
| | a simpler clustering | can make the clustering | parameters, and finding |
| | algorithm (often K- | problem more manageable, | the optimal parameter |
| | means) is applied in | especially when dealing | values may not be |
| | this lower-dimensional | with high-dimensional | straightforward. |
| | space. | data. Global Information | Scaling Issues: The |
| | | Incorporation: Spectral | algorithm may face |
| | | clustering utilizes | challenges in scaling to |
| | | information about the | very large datasets or |
| | | global structure of the data, | high-dimensional data, |
| | | which can be beneficial in | especially when |
| | | finding accurate clusters. | compared to simpler |
| | | | algorithms like K-means. |

In the context of 6G T-MIMO, spectral clustering could be employed for more complex clustering tasks where the data exhibits non-convex structures. However, the computational complexity and scaling issues associated with spectral clustering might pose challenges, especially given the high-dimensional nature and the sheer volume of data in 6G T-MIMO systems. On the other hand, K-means, with its simplicity and scalability, might be better suited for scenarios where computational resources are limited or where the cluster shapes are relatively simple. Each clustering method, including K-means and Spectral Clustering, has its unique strengths and may be suited to different aspects or challenges within the 6G T-MIMO domain.

### Wireless Radio Resource in Orthogonal Frequency Division Multiplexing (OFDM) System

RB: A resource block (RB) in 5G NR is a unit of frequency domain resource allocation that consists of 12 consecutive subcarriers with the same subcarrier spacing configuration. The subcarrier spacing can vary from 15 kHz to 240 kHz depending on the numerology used. An RB can span one or more OFDM symbols durations, depending on the scheduling granularity. An RB is a two-dimensional matrix of resource elements (RE) that covers the entire bandwidth and time (OFDM symbol) duration of a transmission. A resource element (RE) is the smallest unit of time-frequency resource that corresponds to one subcarrier and one OFDM symbol. A resource block group (RBG) consists of multiple contiguous RBs and is used for efficient resource management and allocation in 5G networks. The concept of RBGs enables flexible and dynamic allocation of resources to meet the diverse requirements of different services and applications in 5G communication.

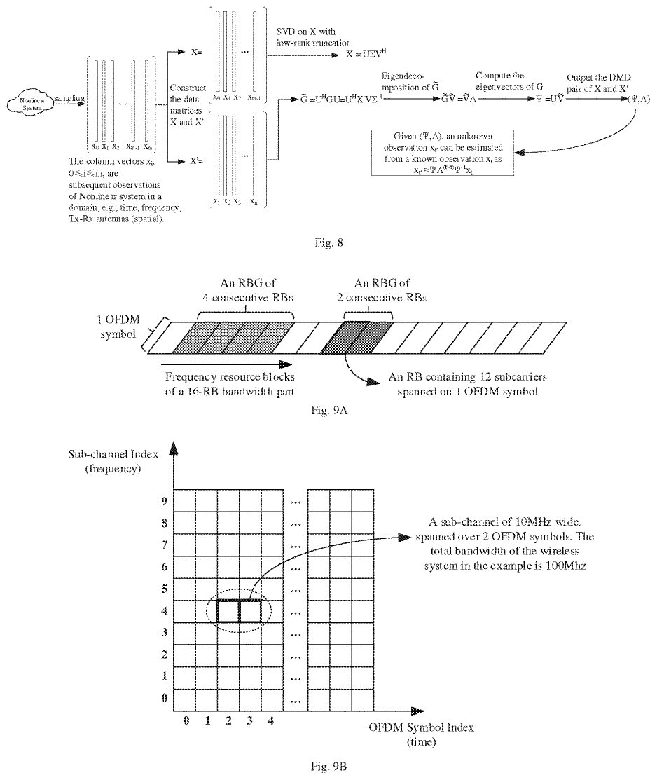

For instance, illustrated in FIG. 9A, various Resource Block Group (RBG) configurations can coexist simultaneously over one OFDM symbol duration: one RBG comprises 16 contiguous Resource Blocks (RBs), while another encompasses 2 contiguous RBs.

Sub-channels: Sub-channels are groups of subcarriers that form the basic units of resource allocation in 5G NR. Subcarriers are the smallest frequency components of an OFDM signal, which is resource element (RE) used by 5G NR. Sub-channels can have different sizes and shapes depending on the numerology, bandwidth and configuration of the 5G NR system.

In FIG. 9B, we examine a wireless system endowed with a total bandwidth of 100 MHz, segmented into 10 sub-channels (also referred to as frequency ranges or the frequency axis), sequentially numbered from 0 to 9, with each sub-channel encompassing a 10 MHz span. The OFDM symbols are methodically indexed along the OFDM symbol (timing) axis, starting from 0 and proceeding with 1, 2, 3, 4, and so on. Consequently, each sub-channel is defined by at least one frequency index along with at least one OFDM symbol index. Illustrated within FIG. 9B, the specific sub-channel associated with frequency index 4 and OFDM symbol indexes 2 and 3 denotes a 10 MHz bandwidth that extends over two OFDM symbols.

To facilitate understanding of the embodiments of this application, some terms about uplink channel estimation is described.

UL sounding by SRS: SRSs are transmitted by the UE to the gNB in allocated time and frequency resources. The gNB uses these signals to estimate the uplink channel state information, such as path loss, delay spread, angle of departure, etc. The gNB then communicates the suitable uplink beamforming parameters to the UE using downlink control information (DCI). The UE uses these parameters to perform beamforming for uplink transmission. Sounding signals are essential for enabling massive MIMO and beam management in 5G NR, which are key technologies for achieving high spectral efficiency and coverage.

Difference and relevance between beamforming and precoding matrix technologies: Beamforming and precoding matrix are two related but distinct concepts in 5G NR. Beamforming is the process of shaping and directing the radio waves from multiple antennas to a specific user or location. Precoding matrix is a set of coefficients that are applied to the data streams before they are transmitted by the antennas. Precoding matrix can be used to achieve different goals, such as spatial multiplexing, diversity, or array gain. In 5G NR, precoding matrix can be selected from a standardized codebook or designed adaptively based on channel state information. Beamforming and precoding matrix work together to optimize the performance of massive MIMO systems in 5G NR.

Precoding matrix: A precoding matrix is a matrix that transforms the data symbols before transmission over a wireless channel in 5G New Radio (NR) system. Precoding matrix can improve the spectral efficiency, reliability, and interference management of the system. In 5G NR, the precoding matrix can be selected from a set of predefined codebooks based on the CSI that the base station (gNB) acquires from the UE. The UE reports a transmitted precoding matrix indicator (TPMI) to indicate the preferred precoding matrix from the codebook. The codebook design follows the technical specifications 38-211 and 38-214 of the 3GPP. In theory, one way to generate a precoding matrix on each subcarrier is to use singular value decomposition (SVD) of the channel matrix on each subcarrier. SVD precoding diagonalizes the channel matrix by taking an SVD and removing the two unitary matrices through pre- and post-multiplication at the transmitter and receiver, respectively. This method can achieve the optimal performance in terms of signal-to-noise ratio (SNR) or mutual information (MI) of the channel, but it requires perfect channel state information at the transmitter, which is not realistic in practice. Therefore, other methods, including SRS-sounding (assuming UL/DL reciprocity) and CSI-RS feedback, hybrid precoding, and one precoding matrix for a RB group, can be used to reduce the complexity and feedback overhead of SVD precoding. Then, the quality of the precoding matrix given by a precoding technique is evaluated by comparing its correlation with the ground-truth precoding matrix (perfect channel information on each subcarrier) during the algorithm implementation stage. The correlation can be measured by the Frobenius norm of the difference between the two matrices. According to the experience, a correlation over 90% indicates a good precoding matrix approximation algorithm.

6G T-MIMO: In the context of 6G technology, T-MIMO, or Terabit-per-second MIMO, refers to a cutting-edge communication approach characterized by the utilization of a base station equipped with up to 1024 antennas and UEs integrated with up to 16 antennas. The technology operates over an expansive bandwidth of up to 500 MHz, effectively catering to high-speed data transmission requirements. Notably, the T-MIMO system operates within the frequency band ranging between 10 GHz and 14 GHz.

DCI: DCI is a critical component in the communication process between the network and UE within the 5G NR framework. It primarily carries information related to scheduling (allocating physical resources) for both downlink data (PDSCH) and uplink data (PUSCH). The DCI helps in adjusting other parameters. DCI is utilized to transport downlink control information for one or more cells associated with a particular Radio Network Temporary Identifier (RNTI). The coding steps involved include Information Element multiplexing, cyclic redundancy check (CRC) attachment, channel coding, and rate matching. DCI is encoded and modulated before being mapped to a specific slot in 5G NR. The DCI carries control information used for scheduling user data on PDSCH on the downlink and physical uplink shared channel (PUSCH) on the uplink. DCI sends dynamic physical layer control messages from the base station to each UE. This information can be either system-wide or UE-specific, and it encompasses aspects of uplink and downlink data scheduling, HARQ management, power control, and other signaling.

Uplink control information (UCI): UCI is a crucial component in 5G NR that is carried by the physical uplink control channel (PUCCH) or PUSCH depending on the scenario. UCI carries control signals from the UE to the base station in the uplink direction. It serves as a counterpart to DCI which travels from gNB to UE. It contains important control information such as HARQ feedback, CSI, and scheduling request (SR). UCI is primarily carried by the PUCCH, but it can also be transported by the PUSCH under certain circumstances. This flexibility contrasts with DCI which is strictly carried by the PDCCH. The content, encoding, modulation, and mapping of UCI to the 5G NR slot via the PUCCH or PUSCH are critical aspects of how UCI functions within the 5G NR framework. The control information conveyed includes channel reports, HARQ-ACK, and scheduling requests.

PMI/RI/CQI: PMI in 5G NR is used for conveying information about the channel from the UE to the base station. PMI, along with the rank indicator (RI) that informs the base station about the number of transmission layers that the UE can reliably receive and channel quality indicator (CQI) that provides feedback on the downlink channel quality, forms part of the CSI feedback that the UE provides to the base station based on the CSI-RS it receives. The base station utilizes the reported CSI to configure various transmission parameters such as the target code rate, modulation scheme, number of layers, and MIMO precoding matrix for subsequent downlink transmissions. The PMI specifically helps in selecting the appropriate precoding matrix to be used for these transmissions, aiming to optimize the performance of the communication link.

In some embodiments, the SRS may be transmitted periodically or aperiodically.

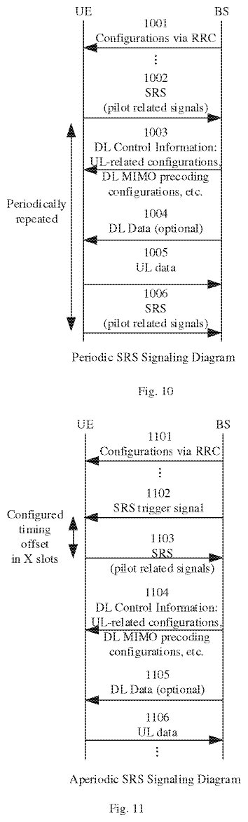

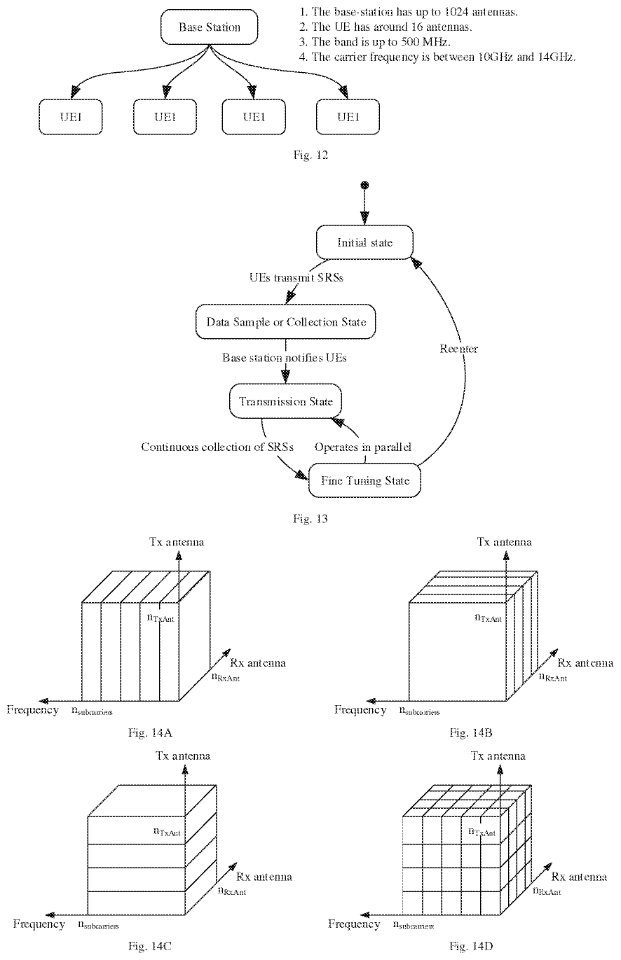

As shown in FIG. 10, the BS may transmit SRS to the UE periodically. The flow of uplink estimation may comprise the following steps:

1001: BS transmits configurations to UE via RRC.

1002: UE transmits SRS to BS.

1003: BS transmits DCI corresponding to the SRS to UE.

BS may transmits DCI corresponding to the SRS to the UE, wherein the DCI may comprise UL-related configurations, DL MIMO precoding configurations, etc.

1004: BS transmits downlink data. This step is optional.

1005: UE transmit uplink data based on the DCI.

In some embodiments, step 1002-1005 may be periodically repeated.

1006: UE transmits SRS to BS.

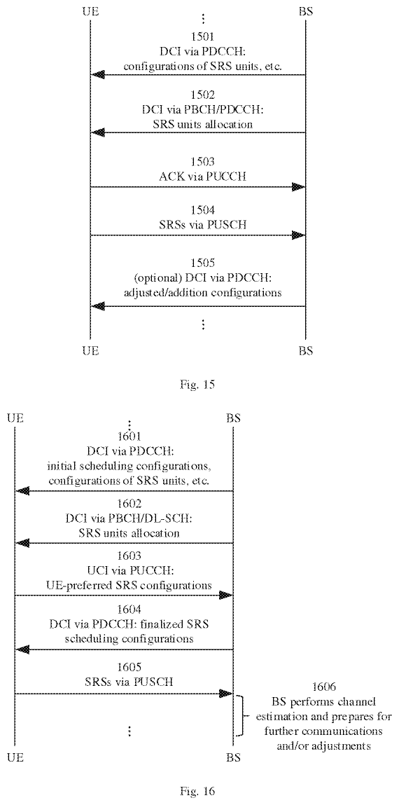

As shown in FIG. 11, the BS may transmit SRS to the UE aperiodically. The flow of uplink estimation may comprise the following steps:

1101: BS transmits configurations to UE via RRC.

1102: BS transmits SRS trigger signal to UE.

1103: UE transmits SRS to BS.

1104: BS transmits DCI corresponding to the SRS to UE.

1105: BS transmits downlink data.

1106: UE transmit uplink data based on the DCI. In some embodiments, the step 1102 and 1103 may repeat according a timing offset (e.g. a redefined or configured timing offset in X slots).

According to the description above, the problems of 6G UL T-MIMO include:

Navigating the extensive channel space due to multiple dimensions, namely sub-carriers, base station antennas, UE antennas, and possible timing symbols.

Overhead, diminished radio efficiency, and escalated storage requirements arising from the necessity for full channel measurement.

Challenges in granularity decision-making for optimizing SRS transmission and channel estimation.

Real-time environment adaptation to capture dynamic environmental changes.

Data sample or collection, common basis generation, and channel reconstruction for efficient uplink transmission.

Cluster-based channel estimation to foster commonality among UEs and reduce reference signal overhead.

Tracking moving UEs and managing transitions between UE clusters to maintain efficient channel estimation.

Simplifying uplink transmission procedures to reduce computational and signaling overheads.

Nested clustering to refine the common basis hierarchy for diverse and dynamic propagation scenarios.

Achieving a feedback-based UL precoding and high-resolution precoding matrix generation as an enhancement over existing 5G NR UL-MIMO precoding techniques.

Embodiments of this disclosure, addresses a gamut of inherent challenges of 6G T-MIMO systems, steering towards optimized radio resource management, enhanced channel estimation, and efficient uplink transmissions. The problems tackled are summarized as follows:

Vast channel space navigation: Some embodiments (e.g. embodiments shown in FIG. 13) lay the foundation for navigating the extensive channel space of T-MIMO, which is exacerbated by the multiplicity of dimensions spanning sub-carriers, base station antennas, UE antennas, and possibly timing symbols.

Overhead, radio efficiency, and storage challenges: The patent underscores the overhead, compromised radio efficiency, and escalated storage requirements when a full channel measurement is necessitated, as delineated in the 5G NR SRS model. It proposes granularity and segmentation to mitigate these issues.

Granularity decision-making: Through a ray-tracing model, some embodiments (e.g. embodiments shown in FIG. 14A to FIG. 18) elucidate an informed approach for granularity decision-making, leveraging environmental knowledge to tailor segmentation, thereby optimizing SRS transmission and channel estimation.

Real-time environment adaptation: It introduces a sensing system integration to capture real-time environmental dynamics, facilitating dynamic updates to the ray-tracing model and consequent granularity alterations.

Data sample or collection and channel reconstruction: Some embodiments (e.g. embodiments shown in FIG. 14A to FIG. 19 to FIG. 21) transition toward a data-driven method for channel estimation and uplink transmission. They introduce a procedure to vectorize data samples, generate a common basis, decide sparsity, and enable channel reconstruction and uplink precoding based on derived dynamic modes.

Cluster-based channel estimation: In light of the time-varying radio environment and expansive cellular coverage of T-MIMO, Some embodiments (e.g. embodiments shown in FIG. 22 to FIG. 25) introduces a cluster-based approach. It aims at fostering commonality among UEs, reducing reference signal overhead, and enabling a fine-tuned channel estimation.

UE tracking and secondary common basis: The patent navigates the challenges posed by moving UEs and varying commonality by proposing a secondary common basis and a tracking mechanism for UEs transitioning between clusters.

Simplified Uplink Transmission Procedure: With the introduction of a centrum dynamic mode, a simplified procedure for uplink transmission is proposed, reducing the computational and signaling overhead.

Nested clustering: A nuanced nested clustering arrangement is envisaged to further refine the common basis hierarchy, addressing the diverse and dynamic propagation scenarios.

Comparison with 5G NR UL-MIMO: Through its embodiments, the disclosure also delineates the advantages over the existing 5G NR UL-MIMO precoding techniques, highlighting the benefits of feedback-based UL precoding and high-resolution precoding matrix generation.

In order to better realize the estimation of 6G T-MIMO uplink channel, embodiments of this application provide a communication method. In this method, the uplink channel space can be divided into M sub-channels. The UE may transmit K sets of SRSs corresponding to K (K≤M) sub-channels in the M sub-channels to BS. With receiving the K sets of SRSs, the BS may determine the channel estimation corresponding to each sub-channel of the K sub-channels based on the K sets of SRSs set, and determine or detect the transformation relationship (transformation relationship may also refers to relationship) between channel estimation of a certain sub-channel (hereinafter referred to as the reference sub-channel) and channel estimation of other sub-channels within the K sub-channels. Then, the BS may transmit a DCI including a first information indicating channel estimation of the reference sub-channel and a second information indicating the transformation relationship between channel estimation of the reference sub-channel and channel estimation of other sub-channels within the K sub-channels to the UE. Finally, the UE can obtain channel estimation of other sub-channels based on channel estimation of the reference sub-channel and the transformation relationship between channel estimation of the reference sub-channel and channel estimation of other sub-channels within the K sub-channels. In this way, the BS does not need to transmit channel estimation of the entire uplink channel to the UE, which reduces the communication resources occupied by the channel estimate transmission.

In some embodiments, a set of SRSs corresponding to a sub-channel may comprise one or more SRSs. For example, a sub-channel may be configured with less SRSs while the size of sub-channel is small or the channel estimation accuracy demand is low, while a sub-channel may be configured with more SRSs while the size of sub-channel is big or the channel estimation accuracy demand is high.

In some embodiments, sub-channel also refers to 6G T-MIMO channel unit or unit or other names.

In some embodiments, the M sub-channels are equal-sized. In those embodiments, the relationship between channel estimation of the first sub-channel and channel estimation of sub-channels within the K sub-channels other than the first sub-channel may be simple, which may reduce the computation resource need for determining the second information by the UE or reconstructing the DL channel by the BS.

In some embodiments, sub-channel may also called unit.

In some embodiments, the information indicating channel estimation of the reference sub-channel may refer to the channel coefficient vector of the reference sub-channel, or information indicating the channel coefficient vector of the reference sub-channel (for example, one or more matrix obtained by estimating the channel coefficients on the SRSs). Correspondingly, the aforementioned transformation relationship can be the transformation relationship between the channel coefficient vector of the reference sub-channel and channel coefficient vectors of other sub-channels in the K sub-channels.

In some embodiments, the information indicating channel estimation of the reference sub-channel may refer to a low-dimension (or low-rank, or low-dimension/low-rank version) channel coefficient vector of the reference sub-channel, or information indicating low-dimension (or low-rank, or low-dimension/low-rank version) channel coefficient vector of the reference sub-channel, (for example, one or more matrix obtained by projecting the channel coefficient vector of the reference sub-channel into a low-dimensional space, or decomposing the channel coefficient). Correspondingly, the aforementioned transformation relationship can be the transformation relationship between low-dimension (or low-rank) channel coefficient vector of the reference sub-channel, and low-dimension (or low-rank) channel coefficient vectors of other sub-channels in the K sub-channels. Since the data amount of the low-dimension channel coefficient vector is smaller than the data amount of the channel coefficient vector, second information based on the low-dimension channel coefficient vector is also has smaller data amount than second information based on the channel coefficient vector, which may reduce the communication resource needed for transmitting the first information and second information.

In some embodiments, a low-dimension/low rank vector of a certain vector is the vector obtained by reducing the dimensionality of the vector. For example, decomposing (e.g. (random) SVD decomposing, QR or QR-based decomposing, (random) POD decomposing, etc.) a vector may obtain a low-dimension/low rank vector of the vector.

In some embodiments, the transformation relationship between channel estimation of the reference sub-channel and channel estimation of other sub-channels may be considered a number of dynamic modes, which may be determined or detected by DMD. For example, the transformation relationship between the channel coefficient vector of the reference sub-channel and channel coefficient vectors of other sub-channels in the K sub-channels may be determined or detected by performing DMD on the channel coefficient vectors of the K sub-channels. For another example, the transformation relationship between low-dimension channel coefficient vector of the reference sub-channel and low-dimension channel coefficient vectors of other sub-channels in the K sub-channels may be determined by performing DMD on the low-dimension channel coefficient vectors of the K sub-channels.

In other embodiments, the transformation relationship between channel estimation of the reference sub-channel and channel estimation of other sub-channels may also be determined through other methods, such as discrete Fourier transform (DFT), fast Fourier transform (FFT), deep neural networks (DNN), etc., which are not limited here.

In some embodiments, the reference sub-channel refers to any sub-channel within the K sub-channels.

In some embodiments, UEs associated to a BS may be clustered to one or more UE clusters. UEs in a UE clusters may share the same aforementioned second information (hereafter referred to shared second information). In those embodiments, the UE may just transmit a set of SRS corresponding to the reference sub-channel. The BS may just determine the first information and transmit the determined first information to the UE, while the shared second information may be transmitted to the UE together with the determined first information or before transmitting the determined first information. In those embodiments, the BS may not transmit the shared second information every time a new first information is determined, which may reduce the communication resource needed for UL channel estimation.

The method in the disclosure may be applied to any form of communication system. For easy understanding of the disclosure, 6G T-MIMO system is adopt in the following description.

Embodiments described herein provides a detailed framework aiming at enhancing the performance of UL-MIMO technology within the realm of 6G T-MIMO technology. The system architecture as delineated comprises of essential components and operational states, each tailored to execute specific processes to achieve optimized UL-MIMO performance.

As shown in FIG. 12, a 6G T-MIMO system comprise a base station, and several UEs (e.g. UE1, UE2, UE3 UE4).

Base station configuration: The system comprises a base station, outfitted with a multitude of antennas, with the count extending up to 1024, facilitating a robust platform conducive for advanced beamforming, precoding matrices, and spatial multiplexing.

UE Configuration: Incorporated within the system are a plurality of UEs, each equipped with a complement of antennas, the number of which reaches around 16.

Transmission bandwidth: The specified transmission bandwidth is extended up to 500 MHz, enabling extensive data throughput capacity.

Operating frequency range: The operational frequency band of the system is delineated between 10 GHz to 14 GHz, aligning with the centimeter wave spectrum.

The configuration shown in FIG. 12 is just an example, in other embodiments, the UE or BS may be configured with more or less antennas, the transmission bandwidth may be wider or narrower, the operating frequency range may be wider or narrower, which is not limited herein.

In some embodiments, the state structure of a T-MIMO system is shown in FIG. 13. The state structure may comprise initial state, data sample collection state, transmission state and fine tuning stage.

Initial state: At the outset, the system, represented by the base station or network infrastructure, deliberates upon the granularity requisite for the UEs to transmit their UL SRS for the measurement of one or multiple, or all contiguous units of a UL MIMO channel. Subsequently, the base station communicates and schedules the UEs to transmit the SRSs based on an initial reference signal placement scheme.

In some embodiments, reference signal placement scheme also refers to pattern (or pattern information) of reference signal (or SRS). The reference signal placement scheme indicates at least one of the following information: frequency interval(s) (frequency domain positioning of the SRSs, such as the exact subcarrier spans they occupy or their corresponding subcarrier interval indexes), time interval(s) (e.g. the actual OFDM symbol time spans or their indexes), index of antennas or antenna ports of the BS, index of antennas or antenna ports of the UE, values (indicating such as modulation schemes, coding rates, or specific attributes related to signal processing that further define the characteristics of the reference signal transmission), antenna port, or transmit power.

Data sample or collection state: After the initial state, the UEs transmit the SRSs in adherence to the prescribed granularity; the base station engages in estimating the received signals. Concurrently, the base station endeavors to discern the common basis and optimal reference signal placement concerning granularity for a unit and applies DMD over the evolution of units to compute the dynamic mode across the contiguous units for the UL channel from each UE.

In some embodiments, a UE may transmit K sets of SRSs corresponding to K (K≤M) sub-channels (also refers to K unit) in the M sub-channels to BS. With receiving the K sets of SRSs, the BS may determine the channel estimation corresponding to each sub-channel of the K sub-channels based on the K sets of SRSs (which comprises the channel estimation of the reference sub-channel (also refers to first information)), and determine or detect the transformation relationship (also refers to second information) between channel estimation of the reference sub-channel and channel estimation of other sub-channels within the K sub-channels.

In some embodiments, the channel estimation may be channel coefficient vector or low-dimension channel coefficient vector.

In some embodiments, the transformation relationship (transformation relationship may also refers to relationship) between channel estimation of the reference sub-channel and channel estimation of other sub-channels within the K sub-channels may be also determined by DFT, FFT, DNN, etc.

In some embodiments, if the UE has been determined to belong to a UE cluster, the BS may just determine the first information. In those embodiments, UEs within a UE cluster may share the same second information (e.g. aforementioned shared second information, G_{centrum}, G_{c-centrum}, or G_{y-centrum} mentioned below).

Transmission state: Upon acquisition of the requisite data, the base station notifies the UEs regarding the learned reference signal placement scheme and the common basis of the UL channel. The base station transmits the dynamic modes and a low-dimensional representation of the estimated UL channel, denoted as c, obtained from one UE's SRS to the respective UE. The UE, in turn, reconstructs the UL channel, computes the precoding matrix, and applies it to the uplink transmission.

In some embodiments, BS may transmit the DCI comprising the aforementioned first information and second information to the UE. With the DCI, the UE may reconstruct the UL channel and transmits uplink data to the BS across the reconstructed UL channel.

In some embodiments, if the second information of a UE cluster comprising the UE has been transmitted to the UE, the DCI may not comprise the second information.

In some embodiments, BS may also transmit a common basis of the UL channel (refers to U) and a low-dimension matrix of the common basis (refers to P), and/or a secondary common basis corresponding to the UE cluster (refers to U_{secondary}) and a low-dimension matrix of the secondary common basis (refers to P_{secondary}) to the UE.

Fine tuning state (also refer to tracking state): Operating concurrently with the transmission state, the fine tuning state entails continuous collection of the SRSs from the UEs, while retiring outdated data. The base station perpetually updates the common basis and optimal reference signal placement scheme, ensuring a refined operational framework.

In some embodiments, the BS may continuously receive SRSs from UE(s) and determine the DCI corresponding to each UE in fine tuning (or tracking) state. With the new-determined DCI, the BS may transmit the new-determined DCI to corresponding to corresponding UE (e.g. transmitting DCI periodically or aperiodically, or the first information and/or the second information in the new-determined DCI changes greatly, etc.).

The procedural transition of the system's state follows a sequential trajectory from the initial state to the data collection state, advancing to the transmission state. The fine tuning state operates in parallel with the transmission state, fostering an adaptive operational environment. The system harbors the capability to reenter the initial state, depicting a cyclical operational paradigm aimed at continually enhancing the UL-MIMO performance within the 6G T-MIMO technology domain.

The benefits emanating from the embodiments shown in FIG. 13 as delineated herein are manifold and contribute significantly towards ameliorating the operational efficiency and performance of the UL-MIMO technology within the 6G T-MIMO domain. The particulars of the benefits are elucidated as follows:

### Granularity-Induced Dimensionality Reduction:

The embodiment introduces a granularity approach in managing the transmission and reception processes between the base station and the UEs. This granularity significantly curtails the practically prohibitive dimensionality that would otherwise be encountered if the entire 6G T-MIMO channel space were to be navigated without such a structured approach. The granularity orchestrated within the framework aids in segmenting the channel space into manageable units, thereby simplifying the complexity and enhancing the efficacy of the system in handling the UL-MIMO operations. This, in turn, renders the system more tractable and operationally efficient.

This granularity-induced dimensionality abatement is further bolstered when synergized with data-driven learning mechanisms, forging a pathway towards more efficient and insightful explorations of the channel space.

By virtue of delineating the channel space into finer granular units, the system inherently curtails the volume of data requisite for each learning iteration. Smaller data samples not only align with the storage and computational constraints but also render the learning process more agile and accurate. The ease of learning facilitated by smaller data samples substantially alleviates the storage demands and computational burdens, thereby rendering the system more adept at swiftly adapting to the channel dynamics.

The data-driven learning, when deployed upon these smaller, granular data segments, demonstrates an enhanced aptitude for discerning the underlying patterns and correlations within the channel behavior. The reduced dimensionality, courtesy of the granularity approach, coupled with the learning algorithm's ability to efficiently process and learn from these smaller data segments, culminates in a more nuanced understanding and representation of the UL-MIMO channel space.

Furthermore, the data-driven learning algorithm thrives on the reduced dimensionality, navigating through the granular data with heightened precision and speed, thereby accelerating the learning curve. The amalgamation of granularity-induced dimensionality reduction with data-driven learning as envisioned in embodiment shown in FIG. 13, symbolizes a pragmatic stride towards more efficient, accurate, and swift learning iterations. This symbiotic confluence significantly enhances the system's capability to swiftly adapt to the evolving channel conditions, thereby optimizing the UL MIMO performance within the expansive realm of 6G T-MIMO technology.

### Data-Driven Learning Enhancement:

The embodiment shown in FIG. 13 underpins a data-driven learning enhancement, which is crucial in navigating the complex terrain of 6G T-MIMO channel space. This learning paradigm is particularly beneficial when intertwined with ray-tracing factors, which are instrumental in decoding the part of the channel intricacies determined by the surrounding environment.

The ray-tracing methodology furnishes a rich tapestry of insights into how the surrounding structures and materials influence the channel conditions. This wealth of environmental data, when assimilated through the data-driven learning mechanism, lays down a robust foundation for unraveling the inherent patterns and dependencies within the channel dynamics.

This fusion of ray-tracing insights with data-driven learning encapsulates a pioneering stride towards achieving an optimized UL-MIMO performance in the ambit of 6G T-MIMO technology, rendering the system adept at decoding the environmental narrative of the channel dynamics, and thereby, fine tuning the UL MIMO operations to resonate with the environmental rhythm.

### Fine Tuning (Also Refer to Tracking) Proficiency:

Embodiments shown in FIG. 13 delineates a meticulously crafted fine tuning state (or tracking state), a pivotal operational phase that perpetuates the system's adeptness in navigating the intricacies of a time-varying radio environment within the 6G T-MIMO domain. The fine tuning state is adept at orchestrating a continuous collection of SRS from the User Equipment (UEs), concurrently retiring data that has aged beyond a predefined threshold of relevancy. This orchestrated data turnover facilitates a living repository of channel information that is both contemporaneous and pertinent.

The overarching merit of this fine tuning apparatus lies in its capacity to foster a dynamic adaptation to the temporal variations inherent in the radio environment. As the radio channel conditions oscillate, be it due to mobility, interference or other environmental factors, the fine-tuning mechanism is agile in discerning these fluctuations. The continual update of the common basis and optimal reference signal placement scheme, predicated on the most recent channel data, ensures that the system's configuration remains optimally aligned with the prevailing channel conditions.

Further, the fine tuning state augments the robustness of the system in the face of time-variant channel impairments, thereby bolstering the reliability and performance of the UL-MIMO operations. Through an orchestrated regime of data collection, analysis, and adaptation, the fine tuning mechanism significantly mitigates the adverse impact of channel variations, thereby preserving the integrity of the communication link between the base station and the UEs.

The inclusion of a fine tuning state, as articulated in embodiment shown in FIG. 13, represents a seminal strategy to combat the challenges posed by a time-varying radio environment, thereby elevating the reliability, efficiency, and overall performance of the UL-MIMO system within the 6G T-MIMO technological sphere.

### Downlink Overhead Reduction Via Dynamic Modes Transmission:

A salient advantage of the embodiment is the transmission of dynamic modes over the air, which remarkably diminishes the downlink overhead. By transmitting the dynamic modes, the embodiment facilitates a streamlined communication between the base station and the UEs. This streamlined communication significantly alleviates the downlink overhead that would otherwise be incurred, thereby augmenting the downlink data transmission efficiency. This benefit is pivotal in fostering an optimized communication link, which is imperative for achieving the objectives of the 6G T-MIMO technology.

In some embodiments, the transmitting of a DCI comprising the aforementioned first information and second information instead of transmitting channel estimation of the whole UL channel also diminishes the communication resource used for UL channel estimation.

### Mitigation of DL/UL Reciprocity Assumption Mismatch:

The embodiment adeptly circumvents the challenges associated with the assumption of DL/UL reciprocity, which often culminates in a mismatch affecting the system performance. By steering clear of the reliance on the DL/UL reciprocity assumption, the embodiment ensures a more accurate and reliable communication framework. This benefit is instrumental in obviating potential inaccuracies and inconsistencies that may arise due to the DL/UL reciprocity assumption, thereby bolstering the reliability and performance of the UL-MIMO operations within the 6G T-MIMO domain.

The detail of the states of the 6G T-MIMO system is described below.

The following embodiments may firstly focus on the initial state, crucial in navigating the vast channel space of 6G T-MIMO, with dimensions spanning over sub-carriers, base station antennas (or antenna ports), UE antennas (or antenna ports), and possibly timing symbols. This vastness makes a full channel measurement for all UEs challenging, a scenario illustrated by the 5G NR SRS model.

Analysis of overhead, radio efficiency, and storage: In 5G NR SRS, one UE requiring a full OFDM symbol in the uplink implies multiple UEs would need multiple OFDM symbols, a situation exacerbated in 6G T-MIMO's significantly larger channel space. This increases overhead, compromises radio efficiency, and demands higher data storage, making data-driven learning from this data set challenging.

Granularity and segmentation: Maintaining granularity across the entire 6G T-MIMO channel space is not realistic. Segmenting this space into smaller units emerges as a practical solution, adjusting the granularity to manageable levels. Alternatives for granularity and segmentation include:

Frequency domain partitioning: Dividing the frequency spectrum into smaller segments or bands, exemplified by: RB segmentation: segmenting into resource blocks; RBG segmentation: grouping resource blocks together; sub-channel segmentation: dividing into smaller sub-channels within the frequency spectrum; frequency-temporal segmentation: segmenting based on both frequency and time intervals.

Space domain partitioning: antenna/antenna port of BS, antenna/antenna port of UE, or antenna grouping: grouping antennas at either the base station or UE to form smaller subsets.

Time domain partitioning.

Illustratively, FIG. 14A-14D shows some ways to segment the uplink channel.

In some embodiments, as shown in FIG. 14A, the uplink channel may be segmented only based on frequency domain. Consider the amount of subcarriers in the uplink channel is n_{subcarriers} and the amount of sub-channels of the uplink channel is M, each sub-channel may be corresponding to n_{subcarriers}/M subcarriers with all Rx antennas and Tx antennas.

In some embodiments, as shown in FIG. 14B, the uplink channel may be segmented only based on Rx antenna ports domain. Consider the amount of Rx antenna ports of the UE is n_{RxAnt} and the amount of sub-channels of the uplink channel is M, each sub-channel may be corresponding to n_{RxAnt}/M Rx antennas with full band.

In some embodiments, as shown in FIG. 14C, the uplink channel may be segmented only based on Tx antenna ports domain. Consider the amount of Tx antenna ports of the UE is n_{TxAnt} and the amount of sub-channels of the uplink channel is M, each sub-channel may be corresponding to n_{TxAnt}/M Tx antennas with full band.

In some embodiments, as shown in FIG. 14D, the uplink channel may be segmented by frequency domain, Tx antenna port domain, and Rx antenna port domain. Consider the amount of Rx antenna ports of the UE is n_{RxAnt}, the amount of Tx antenna ports of the UE is n_{TxAnt}, the amount of subcarriers in the uplink channel is n_{subcarriers}, and the uplink channel is segmented into M₁ (frequency domain)×M₂ (Tx antenna port domain)×M₃ (Rx antenna port domain) sub-channels, each sub-channel may be responding to n_{subcarriers}/M₁ subcarriers, n_{TxAnt}/M₂ Tx antennas and n_{RxAnt}/M₃ Rx antennas.

The ways for segmenting the uplink channel above are just examples, in other embodiments, UE or BS may adopt other ways to segment the uplink channel, which is not limited herein.

The method BS transmitting the pattern for segment the uplink channel or the sub-channel (unit) used for uplink channel estimation (also refers to method for UE notification and scheduling) is described below.

Illustratively, FIG. 15 shows a sequential diagram a first method for UE notification and scheduling.

As shown in FIG. 15, the first method for UE notification and scheduling, the steps may comprise:

1501, BS transmit DCI via PDCCH to UE. The DCI comprises configurations of SRS units, etc.

In some embodiments, step 1501 may be a scheduling commencement step: the BS issues a scheduling message via PDCCH (or other channel, such as PBCH) with associated DCI, specifying units (also refers to sub-channels) for SRS transmission.

1502, BS transmit DCI via physical broadcast channel (PBCH) or PDCCH to UE. The DCI comprises SRS unit allocation.

In some embodiments, step 1502 may be a notification transmission step: the base station utilizes PBCH or PDCCH (or other channel, such as PDSCH) to convey SRS unit allocation. The SRS unit allocation indicates unit or sub-channels using for SRS transmission. 1503, UE transmits acknowledgment (ACK) via PUCCH to BS.

In some embodiments, step 1502 may be a UE acknowledgment step: UEs transmit acknowledgment to BS via PUCCH to notify BS that the UE has received the unit allocation.

1504, UE transmits SRSs via PUSCH.

In some embodiments, step 1504 may be a SRS transmission step: UEs transmit SRSs on designated units (e.g. the unit allocation obtained in step 1502) using the PUSCH (or other channel, such as (PUCCH).

1505, BS transmit DCI via PDCCH. The DCI comprise adjusted/addition configurations. Step 1505 is optional.

In some embodiments, step 1502 may be a feedback loop: the BS receives SRSs, analyzes the channel information, and iterates the scheduling process as necessary, communicating adjustments via PDCCH (or other channel, such as PDSCH). For example, the BS may perform channel estimation based on the received SRSs, and the BS may adjust or add units (or sub-channels) for SRS transmission while the channel estimation doesn't satisfy a predefined condition. Then the BS may notify the US the adjustment or addition of units (sub-channels) for SRS transmission by a DCI via PDCCH.

In some embodiments, the units (or sub-channels) for SRS transmission may also be determined based on an initial scheduling configuration and UE's preference.

Illustratively, FIG. 16 shows a sequential diagram a second method for UE notification and scheduling.

As shown in FIG. 16, the second method for UE notification and scheduling, the steps may comprise:

1601, BS transmit DCI via PDCCH to UE. The DCI comprises initial scheduling configurations, configurations of SRS units, etc.

In some embodiments, step 1501 may be an initial notification step: the BS sends an initial notification via PDCCH, outlining the general scheduling plan and specifying units (or sub-channels) for SRS transmission. In some embodiments, the general scheduling plan and specifying units involve all UEs corresponding to the US.

1602, BS transmit DCI via PBCH/DL-SCH to UE. The DCI comprises of SRS units allocation.

In some embodiments, step 1602 may be a unit allocation step: the BS transmits a detailed unit allocation message via PBCH or a dedicated DL-SCH (or other channel, such as PDSCH), specifying units for SRS transmission.

1603, UE transmit UCI via PUCCH. The UCI comprises UE-preferred SRS configurations (e.g. UE-preferred SRS units or sub-channels for SRS transmission).

In some embodiments, step 1603 may be a UE response step: UEs respond with their capabilities and preferences via PUCCH (or other channel, such as PUSCH). In some embodiments, UE's capabilities and preference indicating the units or sub-channels for SRS transmission preferred by the UE.

1604, BS transmit DCI via PDCCH to UE. The DCI comprises of finalized SRS scheduling configurations.

In some embodiments, step 1604 may be a finalized scheduling step: the BS finalizes the scheduling based on UE's feedback and transmits final scheduling instructions via PDCCH. The BS may determine the units or sub-channels for SRS transmission based on UE's feedback, and transmit the determined units or sub-channels to the UE by a DCI via PDCCH.

1605, UE transmits SRSs via PUSCH.

In some embodiments, step 1605 may be a SRS transmission step: UEs transmit SRSs on designated units (e.g. the units or sub-channels obtained in step 1604) using the PUSCH (or other channel, such as PUCCH).

1606, BS performs channel estimation.

In some embodiments, step 1606 may be a channel estimation step: the BS estimates the channel conditions based on received SRSs and prepares for further communications or adjustments.

With the method in embodiments shown in FIG. 16, the units or sub-channels for SRS transmission are determined based on the preference of UE, which may enhance the quality of SRSs and improve the accuracy of channel estimation of the UL channel.

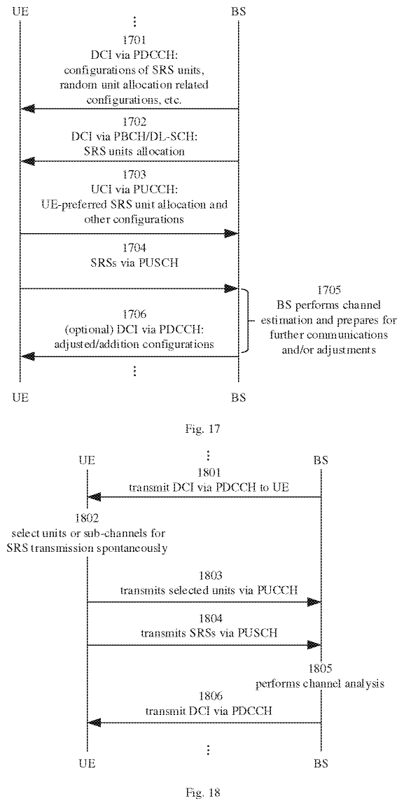

Illustratively, FIG. 17 shows a sequential diagram a third method for UE notification and scheduling.

As shown in FIG. 17, the third method for UE notification and scheduling, the steps may comprise:

1701, BS transmits DCI via PDCCH to UE. The DCI comprises configurations of SRS units, random unit allocation related configurations, etc.

In some embodiments, step 1701 may be a random selection commencement step: the BS specifies units (or sub-channels) for SRS transmission and initializes a random unit allocation process and notifies UEs via PDCCH (or other channel, such as PDSCH or even PBCH).

1702, BS transmits DCI via PBCH/DL-SCH to UE. The DCI comprises of SRS units allocation, the SRS units allocation indicating units that UE can select for SRS transmission.

In some embodiments, step 1702 may be a random unit allocation step: the BS transmits a message via PBCH or PDCCH with a set of units from which UEs can randomly select some or all units for SRS transmission.

1703, UE transmits UCI via PUCCH. The UCI comprises UE-preferred SRS configurations (e.g. units or sub-channels selected by UE for SRS transmission) and other configurations.

In some embodiments, step 1703 may be a UE selection notification step: UEs notify the base station of their selected units or sub-channels for SRS transmission via PUCCH (or other channel, such as PUSCH).

1704, UE transmits SRSs via PUSCH.

In some embodiments, step 1704 may be a SRS transmission step: UEs transmit SRSs on selected units (or sub-channels) using PUSCH.

1705, BS performs channel analysis.

The BS may estimate and analysis the channel conditions based received SRSs and prepare for further communications or adjustments.

In some embodiments, step 1705 may be a channel analysis step: the BS receives SRSs, analyzes the channel information.

1706, BS transmits DCI via PDCCH. The DCI comprise adjusted/addition configurations. Step 1706 is optional.

In some embodiments, step 1706 may be a feedback loop step: if necessary, the BS iterates the random selection process, communicating adjustments via PDCCH, to ensure diverse unit selection and comprehensive channel estimation. For example, the BS may adjust or add units (or sub-channels) for SRS transmission while the channel condition doesn't satisfy a predefined condition. Then the BS may notify the US the adjustment or addition of units (sub-channels) for SRS transmission by a DCI via PDCCH.

Illustratively, FIG. 18 shows a sequential diagram a fourth method for UE notification and scheduling.

As shown in FIG. 18, the fourth method for UE Notification and Scheduling, the steps may comprise:

1801, BS transmits DCI via PDCCH to UE. The DCI indicating UE to determine or select units or sub-channels for SRS transmission spontaneously.

In some embodiments, step 1801 may be a spontaneous selection commencement step: the BS specifies units for SRS transmission and initializes a spontaneous selection process and notifies UEs via PDCCH (or other channel, such as PDSCH).

1802, UE select units or sub-channels for SRS transmission spontaneously.

In some embodiments, step 1802 may be a spontaneous unit selection step: UEs spontaneously choose/select units for SRS transmission. For example, the UE may select units or sub-channels for SRS transmission with either a pre-defined pattern or random pattern.

1803, UE transmits selected units via PUCCH to BS.

In some embodiments, step 1803 may be a UE selection notification step: UEs notify the BS of their selected units via PUCCH (or other channels, such as PUSCH), possibly embedding the scheduling request indicator (SRI) for identification.

In some embodiments, the UE may also transmit its identification (e.g. SRI, serial number, etc.) to the BS, hence the BS may notice selected units for SRS transmission of each UE.

1804, UE transmits SRSs via PUSCH.

In some embodiments, step 1784 may be a SRS transmission step: UEs transmit SRSs on selected units using PUSCH.

1805, BS performs channel analysis.

The BS may estimate and analyse the channel conditions based received SRSs and prepare for further communications or adjustments.

In some embodiments, step 1805 may be a channel analysis step: the BS receives SRSs, analyzes the channel information, acknowledging possible collisions.

1806, BS transmit DCI via PDCCH. The DCI comprise adjusted/addition configurations. Step 1806 is optional.

In some embodiments, step 1806 may be a feedback loop step: feedback loop step: if necessary, the base station iterates the spontaneous selection process, communicating adjustments via PDCCH, to mitigate collision occurrences and enhance channel estimation. For example, the BS may adjust or add units (or sub-channels) for SRS transmission while the channel condition doesn't satisfy a predefined condition. Then the BS may notify the US the adjustment or addition of units (sub-channels) for SRS transmission by a DCI via PDCCH (or other channel, such as PDSCH).

Embodiments shown in FIG. 14A to FIG. 14D, FIG. 15 to FIG. 18 provide methods for segmenting uplink channel and methods for determining/transmitting SRS unit allocation. The particulars of the benefits of those embodiments are elucidated as follows:

Reduction of overhead and enhanced efficiency: By segmenting the vast 6G T-MIMO channel space into manageable units, embodiments shown in FIG. 14A to FIG. 14D, FIG. 15 to FIG. 18 significantly reduce the overhead associated with a full channel measurement, thereby improving radio efficiency and data-driven learning.

Adaptive granularity: The granular adjustment enabled through frequency-domain partitioning, frequency-temporal segmentation, and antenna grouping facilitates a tailored approach to manage the channel space, enhancing the efficiency of SRS transmission and channel estimation.

Effective UE notification and scheduling: The detailed and structured scheduling procedures outlined in the alternatives ensure a well-coordinated communication between the base station and UEs, optimizing the SRS transmission process.

Environmental adaptability: The inclusion of a ray-tracing model, augmented by real-time environmental data from an integrated sensing system, allows for a dynamic adaptation of the granularity based on the current propagation conditions. This environmental adaptability ensures that the segmentation and the resulting channel estimation remain optimal, even in a dynamically changing environment.

Real-Time responsiveness: The real-time adaptation facilitated by the sensing system integration ensures that the system remains responsive to the environmental dynamics, ensuring continuous optimization of the channel estimation process.

Embodiments shown in FIG. 14A to FIG. 14D, FIG. 15 to FIG. 18, with their focus on granularity, segmentation, and real-time environmental adaptation, presents a robust framework for navigating the complex channel space of 6G T-MIMO, setting a solid foundation for enhanced UL-MIMO performance.

The detail of the data sample or collection state is described below.

Illustratively, FIG. 19 shows an example procedure of the data sample or collection state.

As shown in FIG. 19, the data sample or collection state, unfolds as follows:

S1, raw channel coefficients obtained from UE's SRSs.

Post the initial state, the base station assimilates channel estimations from multiple UEs' SRSs in the pre-defined granularity, termed as a unit.

In S1, the BS may receive SRSs from UEs, and perform channel estimation on units (or sub-channels) corresponding to each SRS to obtain raw channel coefficients of the uplink channel.

For example, a UE may transmit K sets of SRSs corresponding to K (K is positive integer) units (or sub-channels) to BS. BS may perform channel estimation based on the K sets of SRSs to obtain channel estimation of the K units corresponding to the UE.

In some embodiments, one UE may transmit SRSs on at least part of sub-channels of the uplink channel. With channel estimation corresponding to one or more UEs, the BS may obtain raw channel coefficients of the uplink channel.

In some embodiments, different UE may transmit different or same sets of SRSs to the BS.

S2, BS preprocesses the raw channel coefficients. S2 is optional.

In S2, the BS performs data cleaning to weed out poor or outlier data, urging the implicated UEs for re-collection. This step augments the data set, catering to the data-driven method.

In some embodiments, if the BS determine that channel estimation of one or more UEs is outlier data, the BS may trigger the one or more UEs to retransmit SRSs, so that the BS can re-determine the channel estimation of the one or more UEs.

S3, BS determines the common basis of the uplink channel.

In some embodiments, each data sample, embodying tensor-like channel coefficients within a unit's granularity, is vectorized into, say, a column vector (e.g. channel coefficient vector). Amassing numerous vectorized data samples spawns a data matrix A. truncated SVD or POD on A yields the common basis U, the left singular vector matrix. For example, an SVD of the data matrix A is mathematically expressed as A=UΣV^{H}, where Σ, U and V^{H} represent the diagonal singular value matrix, the left singular vector matrix, and the conjugate transpose of the right singular vector matrix, respectively. The rank r of U, indicating the number of columns, unveils the commonalities among the UEs' data feedback in SRS.

For example, as shown in FIG. 19, consider that each UE has K determined channel coefficient vectors (h₁, h₂, h₃, . . . , hₖ) and there are M UEs corresponding to the BS, the matrix A may have K×M column, and each column indicating channel coefficient of one sub-channel corresponding to one UE. Then, the BS may perform SVD, or POD, or random/randomized SVD, or random/randomized POD on matrix A to obtain the common basis of the uplink channel (U).

S4, BS determines SRS placement scheme (P) based on the common basis of the uplink channel (U).

In some embodiments, Let r be the minimum number of reference signals within a unit, the base station discerns the sparsity within a unit's granularity, defining the requisite number (r′≥r) of reference signals for precise channel measurement and reconstruction within a unit. Two methodologies are proposed:
a) compute a pivoted QR decomposition (QRD) on U* as U*=QRΠ^{T}, and let P be a matrix that contains the first r′ rows of Π^{T}, where the row pivotal r′ elements in P pinpoint the r′ reference signal placements;
b) or deploy a pseudo random sequence to generate r′. That is, randomly select r′ rows of Π^{T} as P.

The latter necessitates the base station to merely broadcast the random seed, sequence generative method, and r′, whereas the former entails broadcasting the entire reference signal placement scheme P. However, the pivot-QR method allows the UEs to compute the pivoted QRD of U* upon receiving the common basis U, thus the base station only needs to notify the UEs of the reference signal count r′.

S5, BS broadcasts or multicasts the common basis U and the number of reference signals, r′, to the UEs.

In some embodiments, the BS may transmit (broadcast/multicast or using uncast ways) the common basis U and the number of reference signals to UE based one of the following ways:
Broadcasting or multicasting (or using uncast ways) the reference signal placement scheme, P, to the UE;
Broadcasting or multicasting (or using uncast ways) the pseudo random seed and sequence generative method to the UEs; or

Broadcasting or multicasting (or using uncast ways) instructions for using pivoted QRD on the common basis U to generate the r′ reference signal placement scheme by the UEs.

In S5 of embodiment shown in FIG. 19, interaction between the base station and UEs entails the usage of physical channels and control messages:
transmission of common basis U: the base station broadcasts or multicasts the common basis U to the UEs via the PDSCH alongside a DCI message through the PDCCH specifying the relevant parameters for this transmission.
notification of reference signal count r′: similar to the transmission of common basis U, the base station broadcasts or multicasts the number of reference signals r′ to the UEs via PDSCH with corresponding DCI on PDCCH.

Alternative procedures for reference signal placement are shown as follows:
The base station transmits the reference signal placement scheme, P, via PDSCH with corresponding DCI on PDCCH;
The base station sends the pseudo random seed and sequence generative method via PDSCH with corresponding DCI on PDCCH; or
Instructions for utilizing pivoted QRD on the common basis U are sent via PDSCH with corresponding DCI on PDCCH.

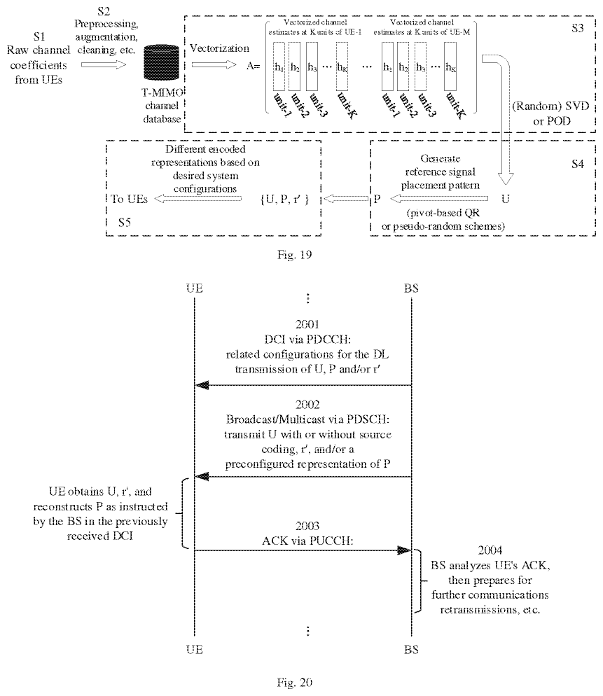

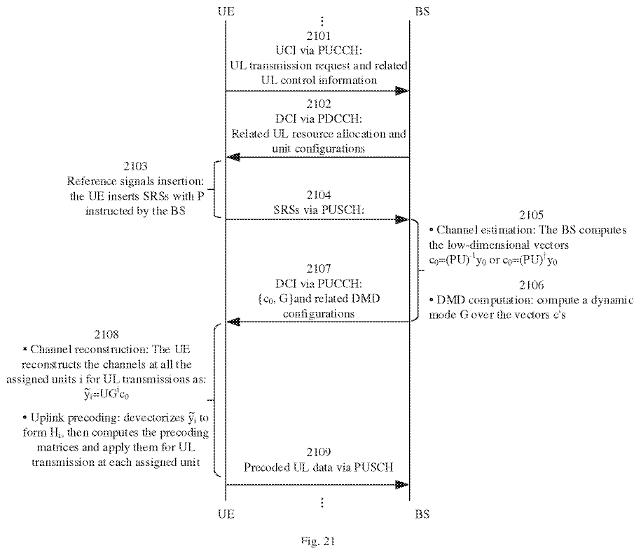

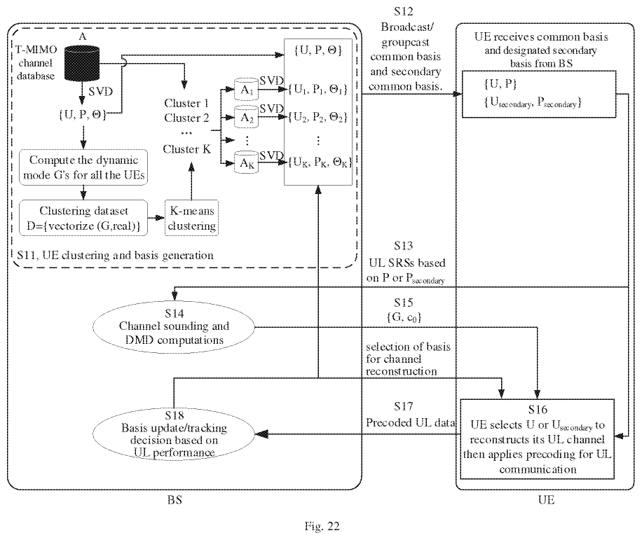

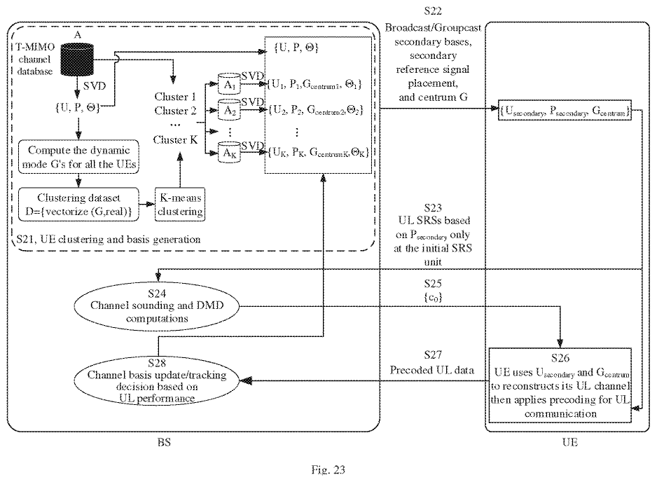

Illustratively, FIG. 20 shows an example diagram of transmitting U, P and/or r′. As shown in FIG. 20, the diagram comprises following steps:

2001, BS transmits DCI via PDCCH to UE. The DCI comprises related configurations for the DL transmission of U, P and/or r′.

2002, BS broadcasts/multicasts via PDSCH. The information for broadcasting/multicasting comprises transmit U with or without source coding, r′, and/or a preconfigured representation of P.

In some embodiments, the BS may transmit U and method for determining P based on U (e.g. pseudo random seed and sequence generative method), or transmit U and r′, or transmit U and P, or U and instructions for determining P by pivoted QRD (or other methods).

2003, UE transmits ACK via PUCCH.

2004, BS analyzes UE's ACK, then prepares for further communications, retransmissions, etc.

In some embodiments, the BS examines the UE's acknowledgment signals to assess communication success, preparing for subsequent transmissions, retransmissions, and additional communication tasks.

In each of these steps, the UEs may acknowledge the receipt and understanding of the transmitted information via the PUCCH, encapsulating the UCI. This structured interaction ensures both the base station and the UEs have a synchronized understanding of the reference signal placements for effective UL channel estimation and reconstruction.

The embodiments shown in FIG. 19 may have benefits as follow:

Efficient data utilization: Data cleaning helps in removing outliers or erroneous data, ensuring that only accurate data is used for further processing. Re-collecting poor data ensures that the dataset remains robust and reliable, forming a solid foundation for data-driven methodologies.

Optimized channel estimation: Utilization of a common basis U from truncated SVD or POD facilitates capturing essential channel characteristics with lesser data. Determining sparsity r′ based on rank r allows for an efficient measurement and reconstruction of the channel with fewer reference signals, reducing the overhead.

Flexibility in reference signal placement: Multiple alternatives for reference signal placement (e.g., pivot-QR, pseudo-random sequence, etc.) allow for adaptable system configurations catering to different operational needs.

Enhanced communication protocols: Utilizing physical channels and control messages like DCI and UCI enables a structured and standardized communication protocol between the base station and UEs. Well-defined notification steps ensure synchronized operations, facilitating accurate channel estimation and further communication adjustments as necessary.

The detail of the transmission state is descripted below.

The transmission state can include the following procedure:

Uplink transmission request: A UE initiates a request for uplink transmission to the base station.

Uplink resource allocation: The base station allocates uplink radio resources for this request. For channel estimation, it specifies units for inserting reference signals. These units can be a number of contiguous units, a number of equally spaced units, or all units, with equally spaced units being crucial for DMD computation. This information is transmitted to the UE via downlink messages.

Reference Signals Insertion: Upon receiving and decoding the configuration messages sent from the base station, the UE inserts reference signals on the selected units in the uplink, utilizing the reference signal placement scheme obtained from embodiment shown in FIG. 19.

Channel estimation: The base station receives the reference signals of the selected uplink units, estimating the channel coefficients on each unit. At each unit, it obtains a vector of estimated channel coefficients, denoted as y. Knowing the reference signal placement P and the common basis U, the base station computes a low-dimensional representation vector c using either (PU) y or (PU) ty.

DMD computation: With a number of vectors c from the selected units, either contiguous or equally spaced, the base station executes DMD to derive a dynamic mode G from c₀, c₁, . . . cₖ. It then sends the information of {cᵢ, G}, i.e., the dynamic mode G and a single vector cᵢ, 0≤i≤k, obtained at the i-th unit, wherein the index I could be indicated by the base station or predefined in standardization. To further reduce the computational complexity and signalling overhead, G can be represented by its eigen-decomposition as G=ΨΛΨ⁻¹, as described in the background section, where Ψ and the eigenvalues placed on the diagonal of Λ, denoted as diag(Λ), could be transmitted instead of G.

DMD configuration parameters: The computation of DMD can be carried out in either direction, from c₀ to cₖ or vice versa from cₖ to c₀. In instances where the direction is not pre-set, it becomes essential for the base station to convey the requisite direction to the UEs. DMD computation can manifest in several distinct variants, each bearing subtle distinctions. Should the variant of DMD not be pre-defined, the base station holds the responsibility to inform the UEs of the specific variant to be employed. The utilization of equal-spaced units in DMD computation leads to the derivation of dynamic mode G which may be aligned to the spacing or adjusted to a non-spaced configuration. In the absence of a pre-defined adjustment, the base station is mandated to communicate to the UEs whether an alignment or adjustment is required.

Channel reconstruction and uplink precoding: The UE receives the information of {cᵢ, G} and can reconstruct the uplink precoding matrix for any unit. For example, consider i=0, the UE first reconstructs the channel using the relation relations Hⱼ=Ucⱼ and cⱼ=G^{j}c₀=ΨΛ^{j}Ψ⁻¹c₀. From Hⱼ, the UE devectorizes it back to the tensor-like representation \tilde{H}ⱼ, then computes the uplink precoding matrix and applies it on the uplink transmission, facilitating a more accurate and efficient uplink communication.

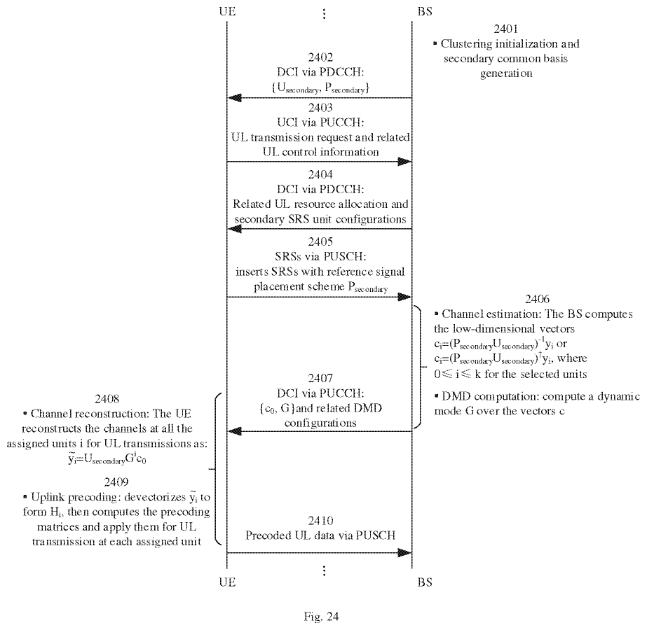

Illustratively, FIG. 21 shows an example diagram of the procedure in the transmission state.

As shown in FIG. 21, correspondent procedural communication between the base station and the UE of the transmission state is as follows:

2101, BS transmit UCI via PUCCH to UE. The UCI comprises UL transmission request and related UL control information.

In some embodiments, step 2101 may be an uplink transmission request step: the UE communicates its desire for uplink transmission to the base station. The request is sent through the PUCCH containing necessary control information.

In some embodiments, UL transmission request and related UL control information may be transmitted across other ways, which is not limited herein.

2102, BS transmits DCI via PDCCH. The DCI comprises related UL resource allocation and unit configurations.

Uplink Resource Allocation: The base station, upon receiving the request, allocates uplink radio resources for the UE's transmission. It designates units for inserting reference signals for channel estimation. These units could be contiguous, equal-spaced, or encompass all units, with the equal-spaced units being pivotal for DMD computation. The base station then transmits this allocation information to the UE using the PDCCH along with a DCI message.

In some embodiments, related UL resource allocation and unit configurations may be transmitted across other ways, which is not limited herein.

2103, UE performs reference signals insertion. In this step, the UE inserts SRSs with P instructed by the BS.

In 2103, the UE executes the insertion of reference signals (SRSs). Specifically, the UE embeds SRSs following the placement matrix or vector (P) directed by the BS.

After receiving and decoding the messages from the base station, the UE inserts reference signals on the selected units in the uplink, following the reference signal placement scheme (P) obtained in the data sample or collection state.

2104, UE transmits SRSs via PUSCH.

UE may transmit SRSs to the BS.

In some embodiments, the reference signals (i.e., SRSs) are transmitted via the PUSCH.

2105, BS performs channel estimation.

In some embodiments, BS may perform channel estimation based on received SRSs. For example, low-dimension channel coefficient vectors of sub-channels corresponding to the received SRSs may also determined by cᵢ=(PU)⁻¹yᵢ while (PU) is reversible or cᵢ=(PU)^{†}yᵢ while (PU) is irreversible, wherein, cᵢ is the low-dimension channel coefficient vector of i-th sub-channel in the sub-channels corresponding to the received SRSs, yᵢ is the channel coefficient vector of i-th sub-channel in the sub-channels corresponding to the received SRSs.

In some embodiments, step 2105 may be a channel estimation step: the BS receives the uplink units and estimates the channel coefficients on each unit. For each unit, it derives a vector of estimated channel coefficients (also refers to channel coefficient vector), denoted as y. Utilizing the reference signal placement P and the common basis U it computes a low-dimensional representation vector c using either (PU)⁻¹y while (PU) is reversible or (PU)^{†} while (PU) is irreversible.

In some embodiments, the BS may just computes the channel coefficient vectors (y) instead of low-dimension channel coefficient vectors.

2106, BS performs DMD computation.

BS may performs DMD computation to determine a relationship between channel estimation of the reference sub-channel and other sub-channels corresponding to the received SRSs.

Consider the received SRSs are corresponding to K+1 sub-channels, with a collection of the c vectors from the selected units, either contiguous or equally spaced, the base station executes DMD to derive a dynamic mode G_{c} from c₀, c₁, c₂, . . . , c_{K}. For example, the UE may performing DMD on c₀, c₁, c₂, . . . , c_{K} based on c_{HighUnits}=G_{c}c_{LowUnits}. Wherein c_{LowUnits}={c₀, c₁, c₂, . . . , c_{K-1}} and c_{HighUnits}={c₁, c₂, . . . , c_{K}}.

In some embodiments, cᵢ refers to the aforementioned first information (the i-th sub-channel in the K+1 sub-channels is adopted as the reference sub-channel), G/G_{c} refers to the aforementioned second information, 0≤i≤K.

In some embodiments, the BS may executes DMD to derive a dynamic mode G_{y} from y₀, y₁, y₂, . . . , y_{K}. In those embodiments, yᵢ refers to the aforementioned first information (the i-th sub-channel in the K+1 sub-channels is adopted as the reference sub-channel), G_{y} refers to the aforementioned second information, 0≤i≤K. For example, the UE may performing DMD on y₀, y₁, y₂, . . . , y_{K} based on y_{HighUnits}=G_{y}y_{LowUnits}. Wherein y_{LowUnits}={y₀, y₁, y₂, . . . , y_{K-1}} and y_{HighUnits}={y₁, y₂, . . . , y_{K}}.

2107, BS transmit DCI via PUCCH to UE. The DCI comprise {c₀, G} and related DMD configurations.

BS may transmit {c₀, G} to UE via PUCCH or other channels.

In some embodiments, BS may transmit {cᵢ, G/G_{c}} or {yᵢ, G_{y}} to the UE via PUCCH or other channels.

In some embodiment, the BS may transmit G, G_{c} or G_{y} itself, or information indicating G, G_{c} or G_{y}, such as one or more matrices determined by decomposing G, G_{c} or G_{y}. For example, the BS may perform Eigen-decomposition on G_{y} to obtain eigenvalue matrix (Ψ_{y}) and eigenvector matrix (Λ_{y}), then transmit Ψ_{y} and Λ_{y} instead of G_{y}. For another example, the BS may perform Eigen-decomposition on G_{c} to obtain eigenvalue matrix (Ψ_{c}) and eigenvector matrix (Λ_{c}), then transmit Ψ_{c} and Λ_{c} instead of G_{c}.

In some embodiments, BS may transmit information of {c₀, G} or {cᵢ, G} to the UE, including any necessary DMD configuration parameters, through the PDCCH in a DCI message. Wherein, c₀ or cᵢ may be the low-dimension channel coefficient vector of the reference sub-channel.

In some embodiments, DMD configuration parameters: If not pre-set, the base station informs the UE of the DMD computation direction, the specific DMD variant to be employed, and whether an alignment or adjustment to G is required based on the equal-spaced units. This information is also conveyed via PDCCH in a DCI message.

2108, UE performs channel reconstruction and uplink precoding.

UE may performs channel reconstruction and uplink precoding based on received DCI message in step 2107.

In some embodiments, the UE, upon receiving {cᵢ, G}, can reconstruct the uplink precoding matrix for any unit. For example, consider i=0 (that is the reference sub-channel is the 0-th sub-channel in the K+1 sub-channels), the UE first reconstructs the channel using the relations Hⱼ=Ucⱼ and cⱼ=G^{j}c₀. From Hⱼ, the UE devectorizes it back to the tensor-like representation \tilde{H}ⱼ, then computes the uplink precoding matrix and applies it on the uplink transmission, facilitating a more accurate and efficient uplink communication. The uplink transmission with the applied precoding matrix is then sent via PUSCH, facilitating a more accurate and efficient uplink communication.

In some embodiments, consider the reference sub-channel is the i-th sub-channel in the K+1 sub-channels (i=0, 1, . . . K), the UE may reconstruct the UL channel using the relations Hᵢ₊ⱼ=Ucᵢ₊ⱼ (or yᵢ₊ⱼ=Ucᵢ₊ⱼ) and cᵢ₊ⱼ=G^{j}cᵢ, 0≤i+j≤K.

In some embodiments, if the K+1 sub-channels are numbered as 1, 2, . . . K+1, consider the reference sub-channel is the i-th sub-channel in the K+1 sub-channels (i=1, 2, . . . K+1), the UE may reconstruct the UL channel using the relations Hᵢ₊ⱼ=Ucᵢ₊ⱼ (or yᵢ₊ⱼ=Ucᵢ₊ⱼ) and cᵢ₊ⱼ=G^{j}cᵢ, 1≤i+j≤K+1.

In some embodiments, consider the reference sub-channel is the i-th sub-channel in the K+1 sub-channels (i=0, 1, . . . K), the UE may reconstruct the UL channel using the relations Hᵢ₊ⱼ=G^{j}yᵢ (or yᵢ₊ⱼ=G^{j}yᵢ), 0≤i+j≤K.

In some embodiments, if the K+1 sub-channels are numbered as 1, 2, . . . K+1, consider the reference sub-channel is the i-th sub-channel in the K+1 sub-channels (i=1, 2, . . . K+1), the UE may reconstruct the UL channel using the relations Hᵢ₊ⱼ=G^{j}yᵢ (or yᵢ₊ⱼ=G^{j}yᵢ), 1≤i+j≤K+1.

In some embodiments, if the G, G_{c} or G_{y} is transmitted with one or more matrices determined by decomposing them, the UE may replace G, G_{c} or G_{y} in the above formulas with corresponding one or more matrices, e.g. G_{y}^{j}=Ψ_{y}Λ_{y}Ψ_{y}⁻¹, G_{c}^{j}=Ψ_{c}Λ_{c}Ψ_{c}⁻¹.

2109, UE transmit precoded UL data.

UE may adopt reconstructed UL channel to precoding UL data and transmit precoded UL data to BS.

The benefits of embodiment shown in FIG. 21 in contrast with the conventional 5G NR uplink MIMO precoding can be elucidated as follows:

Enhanced channel reconstruction: embodiment shown in FIG. 21 introduces a unique method for channel estimation and reconstruction, which diverges from the typical uplink/downlink reciprocity relied upon in 5G NR. Through the use of DMD, the base station can ascertain a dynamic mode G and, in conjunction with an initial vector c, facilitate the UE in reconstructing the uplink channel for any unit. This deviates from the conventional method where the UE uses CSI-RS signals to estimate the UL channel, then selecting the best precoding matrix for uplink transmission by assuming channel reciprocity.

High-resolution precoding: In embodiment shown in FIG. 21, the uplink precoding is no longer contingent on the uplink/downlink reciprocity but is principally based on feedback from the base station. This methodology allows for the generation of the precoding matrix at a significantly higher resolution, potentially even for each subcarrier. This is a leap from the conventional 5G NR uplink MIMO precoding where a set of predefined matrices or mathematical formulas with numerous parameters (as in the case of Type II codebook) are employed for beamforming and precoding.

Adapted reference signal placement: the incorporation of the reference signal placement scheme attained from shown in FIG. 19 aids in a more precise channel estimation. This procedure is more tailored compared to the conventional methods where either the gNB estimates the downlink channel quality from uplink signals or relies on CSI reports from the UE to select the best codebook matrix for downlink transmission.

Facilitated uplink communication: by employing the relation Hⱼ=Ucⱼ and cⱼ=G^{j}c₀ for channel reconstruction, and thereafter computing the uplink precoding matrix based on Hᵢ. Embodiment shown in FIG. 21 facilitates more accurate and efficient uplink communication. This is superior to merely relying on pre-determined codebook matrices or complex mathematical formulas as seen in the conventional 5G NR uplink MIMO precoding methods.

Feedback-driven precoding: The base station's feedback-driven approach in embodiment shown in FIG. 21 supports a more dynamic and adaptable precoding strategy. This contrasts with the more static nature of 5G NR uplink MIMO precoding, which is heavily reliant on pre-defined codebook matrices or mathematical formulas with numerous parameters, thus may not be as flexible or adaptable to varying channel conditions.

Reduced dependency on reciprocity: The conventional 5G NR uplink MIMO precoding often hinges on the assumed reciprocity between uplink and downlink channels for effective precoding. However, embodiment shown in FIG. 21 lessens this dependency by utilizing a feedback-driven approach from the base station for uplink precoding. This could potentially result in a more accurate channel estimation and subsequently improved uplink communication.

The discourse on embodiment shown in FIG. 21 unveils a novel approach towards channel estimation, reconstruction, and uplink precoding, which, when juxtaposed against the conventional 5G NR uplink MIMO precoding, underscores potential advancements in uplink communication efficiency, precoding resolution, and adaptability to varying channel conditions.

To further improve the efficiency for estimating the UL channel and reduce resources used for UL channel, the disclosure further provides methods to adapt the time-varying radio environment in communication systems involving in the fine tuning state (also refer to tracking state). For easy understanding of the disclosure, some terms are described below.

Introduction to time-varying radio environment: The essence of maintaining a fine tuning state concurrently with the transmission state stems from the inherent variability of the wireless environment. For instance, moving UEs can frequently alter the radio environment, impacting the channel conditions. The dynamics of vehicular movement, pedestrian traffic, or even changes in the physical surroundings like construction activities can contribute to the time-varying nature of the radio environment.

6G T-MIMO cell coverage: The 6G T-MIMO system, operating in the centimeter wave spectrum, envisages a macro base station coverage, significantly surpassing the cell size of 5G millimeter wave base stations. This expansive coverage could encapsulate diverse areas like bustling squares, narrow streets, and other urban locales. However, the broad cellular coverage could diminish the commonality among UEs scattered across various zones, thus escalating the reference signal overhead which, in turn, could impair the system efficiency.

Divide-and-conquer approach: To navigate the challenges posed by the extensive coverage and variable environment, a divide-and-conquer methodology is proposed. Herein, UEs are clustered based on their commonality in channel conditions. Each cluster would harbor its own common basis, denoted as secondary common basis U_{secondary} fostering a more refined granularity in channel representation. Consequently, a UE could be associated with two common bases: one representing the broader cellular environment with lesser commonality, and the other embodying the cluster it belongs to, entailing greater commonality and lesser reference signal overhead.

UE movement across clusters: Given the mobility of UEs, transitions from one cluster to another are anticipated. This fluidity necessitates a robust tracking mechanism to ensure UEs are aptly mapped to the clusters they transition into, and are accorded the corresponding secondary common basis.

In the fine tuning state (also refer to tracking state): the system continually updates the secondary common basis employing clustering technology, aligning with the evolving commonality among UEs within clusters. Should a change in cluster membership occur due to UE movement or other factors, the base station informs the affected UEs of the updated secondary common basis via downlink control messages. Concurrently, the base station engages in tracking UEs to ascertain their current clusters, ensuring the alignment of the secondary common basis with the prevailing channel conditions of the respective clusters.

This embodiment accentuates a pragmatic approach towards managing the complexity and variability inherent in a T-MIMO system, by delineating a fine tuning state to keep pace with the dynamic wireless environment, thereby optimizing the system's performance in a diverse and expansive coverage scenario.

As shown in FIG. 22, the diagram for fine-tuning through clustering and secondary basis generation may comprise the following steps:

S11, BS performs UE clustering and basis generation.

BS may cluster UEs into multiple UE clusters (e.g. cluster 1, cluster 2, . . . , cluster K) based on dynamic mode (G) of all UEs, and determine common basis (U or U_{primary}) of the UL channel and secondary common basis (U_{secondary}) of each UE cluster within the multiple UE clusters (e.g. U₁, U₂, . . . , U_{K}).

In some embodiments, the BS may also decompose U to obtain P and Θ, and decompose U₁, U₂, . . . , U_{K} to obtain P₁, P₂, . . . , P_{K} and Θ₁, Θ₂, . . . , Θ_{K}. For example, the BS may decompose U or U₁, U₂, . . . , U_{K} with a SVD method or other methods like POD, random SVD, etc.

In some embodiments, UE may perform clustering post dynamic mode computation: Subsequent to the computation of the dynamic mode G for all UEs as delineated in embodiment shown in FIG. 19, the base station embarks on clustering these UEs predicated on their respective G values (e.g. G_{c} or G_{y}), or on different representations of G, such as its eigenvectors W or its eigenvalues lying on the diagonal of A or both. This clustering can be executed via methods such as K-means, or other viable clustering technologies or algorithms may be employed.

In some embodiments, UE may perform secondary common basis generation: For every identified cluster, the base station reconstitutes the data matrix A pertaining to that cluster (e.g. A₁, A₂, . . . , A_{K} respectively corresponding to cluster 1, cluster 2, . . . , cluster K). Following this, akin to the methodology laid out in embodiment shown in FIG. 19, the base station processes the clustered data to derive a secondary common basis (U_{secondary}) and a consequent secondary reference signal placement scheme (P_{secondary}) exclusively for the UEs within that cluster.

S12, BS broadcasts/groupcasts common basis and secondary common basis.

BS may transmit U, U_{secondary}, P, P_{secondary} to UE (e.g. broadcast, groupcast, or uncast ways).

In some embodiments, the BS then communicates to the clusters of UEs the newly generated secondary common basis (U_{secondary}) and secondary reference signal placement scheme (P_{secondary}). Owing to the granularity of clustering, the secondary common basis is envisaged to be more compact compared to the primary common basis articulated in embodiment shown in FIG. 19, and the secondary reference signal placement scheme necessitates fewer reference signals.

S13, UE transmits SRSs based on P or P_{secondary}.

UE may transmits SRSs (also refers to UL SRSs) based on P or P_{secondary}. In some embodiments, the selection of P and P_{secondary} is determined by UE, or specified by BS, or negotiated between UE and BS.

Given the dual common basis (U and U_{secondary}) availability for each UE, the base station possesses the discretion to select either basis for use during uplink transmission. This selection criterion can be encapsulated within the control messages as outlined in embodiment shown in FIG. 21, ensuring the UEs are apprised of the basis selection for their uplink transmissions.

S14, BS performs channel sounding and DMD computations.

BS may perform channel sounding (or channel estimation) to obtain channel estimation (channel coefficient vectors (y) or low-dimension channel coefficient vectors (c)) corresponding to the received SRSs. Then BS may perform DMD computations (or other ways like DFT, FFT, etc.) to obtain dynamic mode of channel coefficient vectors (refer to G_{y}) of sub-channels of the UL channel or dynamic mode of low-dimension channel coefficient vectors (refer to G or G_{c}) of sub-channels of the UL channel.

In some embodiments, G or G_{c} or G_{y} indicates the transformation relationship between the channel estimation of reference sub-channel (c₀, cᵢ, or yᵢ) and other sub-channels of the UL channel.

In some embodiments, the detail for determined G or G_{c} or G_{y} may refer to step 2106.

S15, BS transmits {G, c₀} to UE.

BS may transmit {G, c₀}, or {Ge, c₀}, or {G, cᵢ}, or {G_{c}, cᵢ}, or {G_{y}, yᵢ} to UE.

In some embodiment, the BS may transmit G, G_{c} or G_{y} itself, or information indicating G, G_{c} or G_{y}, such as one or more matrices determined by decomposing G, G_{c} or G_{y}. For example, the BS may perform Eigen-decomposition on G_{y} to obtain eigenvalue matrix (Ψ_{y}) and eigenvector matrix (Λ_{y}), then transmit Ψ_{y} and Λ_{y} instead of G_{y}. For another example, the BS may perform Eigen-decomposition on G_{c} to obtain eigenvalue matrix (Ψ_{c}) and eigenvector matrix (Λ_{c}), then transmit Ψ_{c} and Λ_{c} instead of G_{c}.

S16, UE selects U or U_{secondary} to reconstructs its UL channel.

With {G, c₀}, or {G_{c}, c₀}, or {G_{y}, c₀}, or {G, cᵢ}, or {G_{c}, cᵢ}, or {G_{y}, cᵢ}, the UE may select U or U_{secondary} to reconstruct its UL channel.

In some embodiments, consider the reference sub-channel is the i-th sub-channel in the K+1 sub-channels (i=0, 1, . . . K), the UE may reconstruct the UL channel using the relations Hᵢ₊ⱼ=Ucᵢ₊ⱼ (or Hᵢ₊ⱼ=U_{secondary}cᵢ₊ⱼ) and cᵢ₊ⱼ=G^{j}cᵢ, 0≤i+j≤K.

In some embodiments, if the K+1 sub-channels are numbered as 1, 2, . . . K+1, consider the reference sub-channel is the i-th sub-channel in the K+1 sub-channels (i=1, 2, . . . K+1), the UE may reconstruct the UL channel using the relations Hᵢ₊ⱼ=Ucᵢ₊ⱼ (or Hᵢ₊ⱼ=U_{secondary}cᵢ₊ⱼ) and cᵢ₊ⱼ=G^{j}cᵢ, 1≤i+j≤K+1.

In some embodiments, consider the reference sub-channel is the i-th sub-channel in the K+1 sub-channels (i=0, 1, . . . K), the UE may reconstruct the UL channel using the relations Hᵢ₊ⱼ=G_{y}^{j}yᵢ, 0≤i+j≤K.

In some embodiments, if the K+1 sub-channels are numbered as 1, 2, . . . K+1, consider the reference sub-channel is the i-th sub-channel in the K+1 sub-channels (i=1, 2, . . . K+1), the UE may reconstruct the UL channel using the relations Hᵢ₊ⱼ=G_{y}^{j}yᵢ, 1≤i+j≤K+1.

In some embodiments, if the G, G_{c} or G_{y} is transmitted with one or more matrices determined by decomposing them, the UE may replace G, G_{c} or G_{y} in the above formulas with corresponding one or more matrices, e.g. G_{y}^{j}=Ψ_{y}Λ_{y}^{j}Ψ_{y}⁻¹, G_{c}^{j}=Ψ_{c}Λ_{c}^{j}Ψ_{c}⁻¹.

S17, UE transmits precoded UL data.

UE may adopt reconstructed UL channel to precoding UL data and transmit precoded UL data to BS.

S18, BS make channel basis update/tracking decision based on UL performance. Step S18 is optional.

In some embodiments, BS may detect or monitor the performance of UL channel, and make channel basis update/tracking decision based on UL performance. For example, if the UL performance satisfies a predefined condition, the BS may update U, P, U_{secondary} or P_{secondary}.

In some embodiments, the BS may transmit selection of basis for channel reconstruction (indicating U or U_{secondary}) to UE, so that the UE may reconstruct its UL channel based on the basis instructing by the BS.

In some embodiments, the BS may update basis and scheme upon cluster transition: Should the base station discern a transition of a UE from one cluster to another, it is incumbent upon the base station to update the secondary common basis and secondary reference signal placement scheme accorded to the transitioning UE. The determination of such transitions could be multifaceted:

Predicated on uplink transmission performance metrics such as packet error rate which could intimate a potential cluster transition; or
Leveraging sensing data that signifies the mobility of the UE, thereby inferring a potential shift in cluster membership.

In some embodiments, UEs in a UE cluster may share the same dynamic mode (e.g. G or G_{c} or G_{y}), which may further reduce resource used for UL channel estimation.

In some embodiments, the selection of common basis for uplink transmission above can be further optimized:

In some embodiments, the UE clustering may be performed based on the dynamic mode (e.g. aforementioned G, G_{c}, G_{y}) corresponding to each UE.

Clustering UEs based on their dynamic mode G (or G_{c}, or G_{y}) leads to a likely scenario where the G is quite similar for UEs within a single cluster. This similarity comes from the nature of the dynamic mode G, which acts as a kind of 2-nd order derivative on the channel, showing more steadiness as per the Kolmogorov theory.

Additionally, the clustering method often provides a central dynamic mode, termed as G_{centrum}. For example, a K-means method results in a centrum dynamic mode. This centrum dynamic mode G_{centrum} might be suitable for all the UEs within the UE cluster.

With the above scenarios, a sensible simplification in embodiment shown in FIG. 21 when using the secondary common basis U_{secondary} could be outlined as follows:

Initially, the base station sends the centrum dynamic mode G_{centrum}, along with the secondary common basis U_{secondary} and the secondary reference signal placement scheme P_{secondary} to the UEs within the cluster, similar to the process in embodiment shown in FIG. 19.

Next, in embodiment shown in FIG. 21, the base station allocates a single unit to a UE within the cluster.

The UE then sends the reference signals on the selected unit using the secondary reference signal placement scheme P_{secondary}, helping the base station to estimate the channel coefficients of this unit during the uplink, and get the low-dimensional variable vector c₀ on the selected unit.

The base station then sends the low-dimensional variable vector c₀ to that UE.

Upon receipt, the UE use c₀ and G_{centrum} to compute the other cᵢ values that the UE is interested in. Then, each cₖ along with the secondary common basis U_{secondary} is used to form \tilde{y}ᵢ=U_{secondary} cᵢ and cᵢ=(G_{centrum})ⁱc₀, aiding in better channel estimation and uplink transmission.

In some embodiments, consider the reference sub-channel is the i-th sub-channel in the K+1 sub-channels (i=0, 1, . . . K), the UE may reconstruct the UL channel using the relations \tilde{y}ᵢ=U_{secondary}cᵢ₊ⱼ and cᵢ₊ⱼ=(G_{centrum})ⁱcᵢ, 0≤i+j≤K.

In some embodiments, if the K+1 sub-channels are numbered as 1, 2, . . . K+1, consider the reference sub-channel is the i-th sub-channel in the K+1 sub-channels (i=1, 2, . . . K+1), the UE may reconstruct the UL channel using the relations \tilde{y}ᵢ=U_{secondary}cᵢ₊ⱼ and cᵢ₊ⱼ=(G_{centrum})^{j}cᵢ, 1≤i+j≤K+1.

In some embodiments, consider the UEs are clustered based on G_{y} and the cluster centrum is G_{y-centrum}, the UE may reconstruct the UL channel using the relations \tilde{y}ᵢ=(G_{y-centrum})ⁱyᵢ, 0≤i+j≤K.

In some embodiments, consider the UEs are clustered based on G_{y} and the cluster centrum is G_{y-centrum}, if the K+1 sub-channels are numbered as 1, 2, . . . K+1, consider the reference sub-channel is the i-th sub-channel in the K+1 sub-channels (i=1, 2, . . . K+1), the UE may reconstruct the UL channel using the relations yᵢ=(G_{y-centrum})ⁱyᵢ, 1≤i+j≤K+1.

In some embodiments, if the G_{c-centrum} or G_{y-centrum} is transmitted with one or more matrices determined by decomposing them, the UE may replace G_{c} or G_{y} in the above formulas with corresponding one or more matrices, e.g. G_{y-centrum}^{j}=Ψ_{y-centrum}Λ_{y-centrum}^{j}Ψ_{y-centrum}⁻¹, G_{c-centrum}^{j}=Ψ_{c-centrum}Λ_{c-centrum}^{j}Ψ_{c-centrum}⁻¹.

This revised step displays a practical simplification, using the clustering and secondary common basis to improve the channel estimation and uplink transmission steps, potentially enhancing the operational effectiveness and performance of the T-MIMO system.

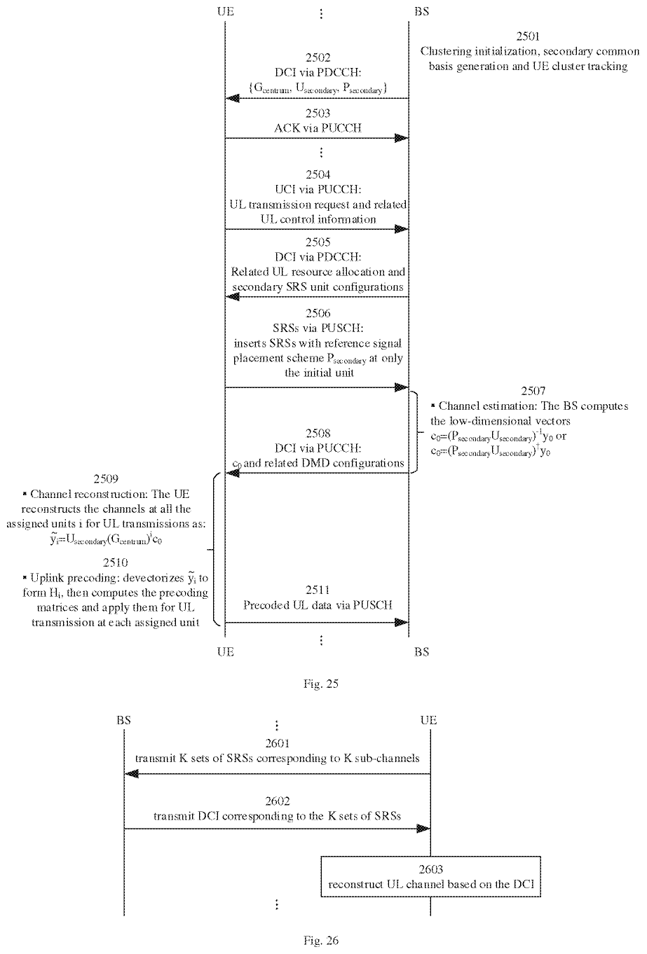

As shown in FIG. 23, the diagram for procedure between BS and UE using centrum dynamic mode is:

S21, BS performs UE clustering and basis generation.

BS may cluster UEs in to multiple UE clusters based on dynamic mode (G) of all UEs, and determine common basis (U or U_{primary}) of the UL channel and secondary common basis (U_{secondary}) of each UE cluster within the multiple UE clusters. The detail may refer to aforementioned S11.

In some embodiments, the BS may also determine the centrum G for each UE cluster. For example the BS may calculate the average, weighted average, etc. of the dynamic modes of all UEs in a UE cluster to obtain the centrum G corresponding to the UE cluster, e.g. G_{centrum}, G_{centrum2}, . . . , G_{centrum} respectively corresponding to cluster 1, cluster 2, . . . , cluster K.

BS may Cluster UEs based on their dynamic mode G (or G_{c} or G_{y}) leads to a likely scenario where the G is quite similar for UEs within a single cluster. This similarity comes from the nature of the dynamic mode G, which acts as a kind of 2-nd order derivative on the channel, showing more steadiness as per the Kolmogorov theory.

In some embodiments, G_{centrum} of a cluster may be G_{c-centrum} while the UEs is clustered by G_{c} of UEs, or G_{y-centrum} while the UEs is clustered by G_{y} of UEs.

S22, BS broadcasts/groupcasts of secondary common basis, secondary reference signal placement and G_{centrum}.

BS may transmit U_{secondary}, P_{secondary} and G_{centrum} to UE by broadcasting, groupcasting or uncasting ways.

In some embodiment, the BS may transmit G_{c-centrum} or G_{y-centrum} itself, or information indicating G_{c-centrum} or G_{y-centrum}, such as one or more matrices determined by decomposing G_{c-centrum} or G_{y-centrum}. For example, the BS may perform Eigen-decomposition on G_{y-centrum} to obtain eigenvalue matrix (Ψ_{y-centrum}) and eigenvector matrix (Λ_{y-centrum}), then transmit Ψ_{y-centrum} and Λ_{y-centrum} instead of G_{y-centrum}. For another example, the BS may perform Eigen-decomposition on G_{c}-centrum to obtain eigenvalue matrix (Ψ_{c-centrum}) and eigenvector matrix (Λ_{c-centrum}), then transmit Ψ_{c-centrum} and Λ_{c-centrum} instead of G_{c-centrum}. In those embodiments, the one or more matrices determined by decomposing G_{c-centrum} or G_{y-centrum} may have smaller data amount than G_{c-centrum} or G_{y-centrum} itself, which may reduce the communication resource needed for transmitting Go-centrum or G_{y-centrum}.

S23, UE transmits SRSs based on P_{secondary} only at the initial SRS unit.

UE may transmit a set of SRSs (also refers to UL SRSs) at the initial SRS unit(s) (e.g. one or more sub-channels comprising a reference sub-channel).

In some embodiments, the initial SR unit(s) may be predefined unit(s), or determined by the BS or UE, or negotiated by the BS and the UE.

S24, BS performs channel sounding and DMD computations.

BS performs channel sounding to determine the channel estimation corresponding to the SRSs. For example, the BS may determine the channel coefficient vector of the reference sub-channel (yᵢ) or the low-dimension channel coefficient vector of the reference sub-channel (c₀ or cᵢ).

In some embodiments, the BS may perform DMD computations on channel estimation of the initial SRS units (or sub-channels) to obtain the dynamic mode corresponding to UE. Then the BS may determine if the UE cluster that the UE belonging to changed based on the dynamic mode corresponding to UE. If the UE cluster that the UE belonging to changes to a new UE cluster, the BS may transmit the centrum G (e.g. G_{c-centrum}, G_{y-centrum}, etc.) of the new UE cluster to the UE, so that the UE may reconstruct its UL channel based on the centrum G of the new UE cluster.

S25, BS transmits {c₀} to UE.

BS may transmit channel estimation of the reference sub-channel (e.g. yᵢ, c₀ or cᵢ) to the UE.

S26, UE uses U_{secondary} and G_{centrum} to reconstructs its UL channel.

UE may reconstruct its UL channel based on received channel estimation.

In some embodiments, consider the reference sub-channel is the i-th sub-channel in the K+1 sub-channels (i=0, 1, . . . K), the UE may reconstruct the UL channel using the relations \tilde{y}ᵢ=U_{secondary}cᵢ₊ⱼ and cᵢ₊ⱼ=(G_{centrum})^{j}cᵢ, 0≤i+j≤K.

In some embodiments, if the K+1 sub-channels are numbered as 1, 2, . . . K+1, consider the reference sub-channel is the i-th sub-channel in the K+1 sub-channels (i=1, 2, . . . K+1), the UE may reconstruct the UL channel using the relations (=U_{secondary}cᵢ₊ⱼ and cᵢ₊ⱼ=(G_{centrum})^{j}cᵢ, 1≤i+j≤K+1.

In some embodiments, consider the UEs are clustered based on G_{y} and the cluster centrum is G_{y-centrum}, the UE may reconstruct the UL channel using the relations yᵢ=(G_{y-centrum})ⁱyᵢ, o≤i+j≤K.

In some embodiments, consider the UEs are clustered based on G_{y} and the cluster centrum is G_{y-centrum}, if the K+1 sub-channels are numbered as 1, 2, . . . K+1, consider the reference sub-channel is the i-th sub-channel in the K+1 sub-channels (i=1, 2, . . . K+1), the UE may reconstruct the UL channel using the relations yᵢ=(G_{y-centrum})ⁱyᵢ, 1≤i+j≤K+1.

S27, UE transmit precoded UL data.

UE may adopt reconstructed UL channel to precoding UL data and transmit precoded UL data to BS.

S28, BS makes channel basis update/tracking decision (also refers to basis update/tracking decision) based on UL performance.

In some embodiments, BS may detect or monitor the performance of UL channel, and make channel basis update/tracking decision based on UL performance. For example, if the UL performance satisfy a predefined condition, the BS may update U, P, U_{secondary} or P_{secondary}.

In some embodiments, BS may transmit U_{secondary}, P_{secondary} and G_{centrum} corresponding to a new UE cluster to the UE once the UE move to the new UE cluster.

With the method shown in FIG. 23, the BS may perform less DMD computations and transmit less information to the UE, which may reduce resource for UL channel estimation.

Illustratively, FIG. 24 shows a sequential diagram corresponding to the methods shown in FIG. 22, in which the G_{centrum} is not adopted.

As shown in FIG. 24, the method comprises the following steps:

2401, BS performs clustering initialization and secondary common basis generation.

In some embodiments, the BS may perform clustering initialization and secondary common basis generation to determine U_{secondary}, P_{secondary} of each UE cluster, and/or U, P of the UL channel. The detail may refer to the aforementioned step S11.

Clustering initialization: The base station computes the dynamic mode G (or G_{c} or G_{y}) for all UEs as per embodiment shown in FIG. 19. Utilizing the computed G, the base station clusters UEs via a method such as K-means or other suitable clustering algorithms.

Secondary common basis generation: For each cluster, the base station recreates the data matrix A and performs a learning method akin to embodiment shown in FIG. 19 on the clustered data to generate a secondary common basis and a secondary reference signal placement scheme.

2402, BS transmits DCI via PDCCH to UE. The DCI comprises U_{secondary} and P_{secondary}.

BS may transmits U_{secondary} and P_{secondary} to UE via PDCCH or other channels like PBCH.

In step 2402, the BS may perform notification of secondary common basis: The base station sends a message via PDCCH with DCI to the clustered UEs, notifying them of the secondary common basis (U_{secondary}) and secondary reference signal placement scheme (P_{secondary}).

2403, UE transmits UCI via PUCCH to BS. The UCI comprises UL transmission request and related UL control information.

UE may transmit a UCI comprising UL transmission request to BS while there are UL data to be transmitted.

In some embodiments, the UL transmission request requests uplink resources from the base station.

2404, BS transmits DCI via PDCCH to UE. The DCI comprises related UL resource allocation and secondary SRS unit configurations.

The BS transmits UL resource allocation and secondary SRS unit configurations to UE in response to the UCI comprising UL transmission request.

In step 2404, the base station, through PDCCH and DCI, allocates uplink resources specifying a number of units for reference signal insertion using the secondary reference signal placement scheme.

In some embodiments, the related UL resource allocation and secondary SRS unit configurations may be transmitted in other signaling or other channel, which is not limited herein.

2405, UE transmits SRSs via PUSCH to BS.

UE may transmits SRSs via PUSCH to BS according to the UL resource allocation notified by the BS.

The UE inserts the reference signals on the specified units using the secondary reference signal placement scheme (P_{secondary}) and transmits it on the PUSCH.

2406, BS performs channel estimation and DMD computation.

Upon receiving the uplink signals, the base station estimates the channel coefficients (channel coefficient vector (y) or low-dimension channel coefficient vector (c)) on the specified units to obtain a number of vectors c (or y) and compute the dynamic mode G (G_{c} or G_{y}) among the number of vectors c or y.

In some embodiments, the detail for DMD computation may refer to step 2106 or embodiments shown in FIG. 8.

2407, BS transmits DCI via PUCCH to UE. The DCI comprises {c₀, G} and related DMD configurations. The base station transmits the initial low-dimensional variable vector c₀ (or cᵢ or yᵢ) and dynamic mode G (or G_{c} or G_{y}) and to the UE via PDCCH or other channels.

In some embodiment, the BS may transmit G_{c} or G_{y} itself, or information indicating G_{c} or G_{y}, such as one or more matrices determined by decomposing G_{c} or G_{y}. For example, the BS may perform Eigen-decomposition on G_{y} to obtain eigenvalue matrix (Ψ_{y}) and eigenvector matrix (Λ_{y}), then transmit Ψ_{y} and Λ_{y} instead of G_{y}. For another example, the BS may perform Eigen-decomposition on G_{c} to obtain eigenvalue matrix (Ψ_{c}) and eigenvector matrix (Λ_{c}), then transmit Ψ_{c} and Λ_{c} instead of Ge.

2408, UE performs channel reconstruction.

The UE, utilizing c₀ and G, calculates the other cₖ values. Each cₖ, along with the secondary common basis U_{secondary}, is used to form Hᵢ (or yᵢ), 0≤i≤k.

In some embodiments, consider the reference sub-channel is the i-th sub-channel in the K+1 sub-channels (i=0, s1, . . . K), the UE may reconstruct the UL channel using the relations Hᵢ₊ⱼ=U_{secondary}cᵢ₊ⱼ (or yᵢ₊ⱼ=U_{secondary}cᵢ₊ⱼ) and cᵢ₊ⱼ=G^{j}cᵢ, 0≤i+j≤K.

In some embodiments, if the K+1 sub-channels are numbered as 1, 2, . . . K+1, consider the reference sub-channel is the i-th sub-channel in the K+1 sub-channels (i=1, 2, . . . K+1), the UE may reconstruct the UL channel using the relations Hᵢ₊ⱼ=U_{secondary}cᵢ₊ⱼ (or yᵢ₊ⱼ=U_{secondary}cᵢ₊ⱼ) and cᵢ₊ⱼ=G^{j}cᵢ, 1≤i+j≤K+1.

In some embodiments, consider the reference sub-channel is the i-th sub-channel in the K+1 sub-channels (i=0, 1, . . . K), the UE may reconstruct the UL channel using the relations Hᵢ₊ⱼ=G_{y}^{j}yᵢ (or yᵢ₊ⱼ=G_{y}^{j}yᵢ), 0≤i+j≤K.

In some embodiments, if the K+1 sub-channels are numbered as 1, 2, . . . K+1, consider the reference sub-channel is the i-th sub-channel in the K+1 sub-channels (i=1, 2, . . . K+1), the UE may reconstruct the UL channel using the relations Hᵢ₊ⱼ=G_{y}^{j}yᵢ (or yᵢ₊ⱼ=G_{y}^{j}yᵢ), 1≤i+j≤K+1.

In some embodiments, if the G, G_{c} or G_{y} is transmitted with one or more matrices determined by decomposing them, the UE may replace G, G_{c} or G_{y} in the above formulas with corresponding one or more matrices, e.g. G_{y}^{j}=Ψ_{y}Λ_{y}^{j}Ψ_{y}⁻¹, G_{c}^{j}=Ψ_{c}Λ_{c}^{j}Ψ_{c}⁻¹.

2409, UE performs uplink precoding.

The UE computes the uplink precoding matrix and applies it on the uplink transmission based on the reconstructed UL channel.

2410, UE transmits precoded UL data via PUSCH to UE.

UE may adopt reconstructed UL channel to precoding UL data and transmit precoded UL data to BS

In some embodiments, if the base station senses or identifies that a UE is transitioning from one cluster to another, possibly due to movement or changing channel conditions, it sends a message via PDCCH informing the UE of the new secondary common basis and secondary reference signal placement scheme pertaining to the new cluster. Correspondingly, UE acknowledges the receipt and understanding of the new secondary common basis and secondary reference signal placement scheme via PUCCH.

Illustratively, FIG. 25 shows a sequential diagram corresponding to the methods shown in FIG. 23, in which the G_{centrum} is adopted.

As shown in FIG. 25, the method comprises the following steps:

2501, BS performs clustering initialization, secondary common basis generation and UE cluster tracking to determine U_{secondary}, P_{secondary}, G_{centrum} of each UE cluster.

The base station computes the dynamic mode G (or G_{c} or G_{y}) for all UEs as per embodiment shown in FIG. 19. Utilizing the computed G, the base station clusters UEs via a method such as K-means or other suitable clustering algorithms, deriving a centrum dynamic mode G_{centrum} (G_{c-centrum} or G_{y-centrum}) of each cluster.

Secondary common basis generation: For each cluster, the base station recreates the data matrix A and performs a learning method akin to embodiment shown in FIG. 19 on the clustered data to generate a secondary common basis and a secondary reference signal placement scheme.

2502, BS transmits DCI via PDCCH to UE. The DCI comprises U_{secondary}, P_{secondary} and G_{centrum}.

BS may transmit U_{secondary}, P_{secondary} and G_{centrum} (or G_{c-centrum}, G_{y-centrum}) to UE via PDCCH or other channels.

The base station sends a message via PDCCH with DCI to the clustered UEs, notifying them of the secondary common basis (U_{secondary}), secondary reference signal placement scheme (P_{secondary}), and G_{centrum} (or G_{c-centrum}, G_{y-centrum}).

In some embodiment, the BS may transmit G_{c-centrum} or G_{y-centrum} itself, or information indicating G_{c-centrum} or G_{y-centrum}, such as one or more matrices determined by decomposing G_{c}-centrum or G_{y-centrum}. For example, the BS may perform Eigen-decomposition on G_{y-centrum} to obtain eigenvalue matrix (Ψ_{y-centrum}) and eigenvector matrix (Λ_{y-centrum}), then transmit Ψ_{y-centrum} and Λy-centrum instead of G_{y-centrum}. For another example, the BS may perform Eigen-decomposition on G_{c}-centrum to obtain eigenvalue matrix (Ψ_{c-centrum}) and eigenvector matrix (Λ_{c-centrum}), then transmit Ψ_{c}-centrum and Λ_{c-centrum} instead of G_{c-centrum}.

2503, UE transmits ACK via PUCCH to BS. Step 2503 is optional.

With receiving U_{secondary}, P_{secondary} and G_{centrum}, UE may transmits ACK to BS to notify BS that U_{secondary}, P_{secondary} and G_{centrum} have been received.

2504, UE transmits UCI via PUCCH to BS. The UCI comprises UL transmission request and related UL control information.

UE may transmit a UCI comprising UL transmission request to BS while there are UL data to be transmitted.

The UL transmission request requests uplink resources from the base station.

2505, BS transmits DCI via PDCCH to UE. The DCI comprises related UL resource allocation and secondary SRS unit configurations.

The BS transmits UL resource allocation and secondary SRS unit configurations to UE in response to the UCI comprising UL transmission request.

In step 2505, the base station, through PDCCH and DCI, allocates uplink resources specifying a unit for reference signal insertion using the secondary reference signal placement scheme (P_{secondary}).

In some embodiments, the related UL resource allocation or secondary SRS unit configurations may indicate the reference sub-channel (or unit) that the UE should insert or place SRS(s).

2506, UE transmits SRSs via PUSCH to BS.

The UE inserts the reference signals on the specified unit(s) (e.g. one or more units/sub-channels comprising a reference sub-channel/unit) using the secondary reference signal placement scheme and transmits it on the PUSCH.

In some embodiments, the specified unit(s) also refers to initial unit(s) or initial SRS unit(s), which indicating one or more sub-channels (or units) comprising the reference sub-channel (or unit).

In some embodiment, the UE just transmit one set of SRSs corresponding to the reference sub-channel. The reference sub-channel may be any sub-channel in sub-channels of the UL channel.

2507, BS performs channel estimation.

BS may perform channel estimation based on received SRSs to obtain the channel estimation of the reference sub-channel (e.g c₀, cᵢ, yᵢ). In some embodiments, upon receiving the uplink signals (SRSs transmitted by UE), the base station estimates the channel coefficients on the specified unit to obtain the initial vector c₀.

In some embodiments, the BS may perform DMD computations on channel estimation of sub-channels corresponding to received SRSs to obtain the dynamic mode corresponding to UE. Then the BS may determine if the UE cluster that the UE belonging to changed based on the dynamic mode corresponding to UE. If the UE cluster that the UE belonging to changes to a new UE cluster, the BS may transmit the centrum G (e.g. G_{c-centrum}, G_{y}-centrum, etc.) of the new UE cluster to the UE, so that the UE may reconstruct its UL channel based on the centrum G of the new UE cluster.

2508, BS transmits DCI via PUCCH to UE. The DCI comprises c₀ and related DMD configurations.

BS may transmit channel estimation of the reference sub-channel (e.g c₀, cᵢ, yᵢ) to the UE.

In some embodiments, the base station transmits the initial low-dimensional variable vector c₀ to the UE via PDCCH.

2509, UE performs channel reconstruction.

UE may perform channel reconstruction of the UL channel based on received c₀, cᵢ, or yᵢ.

In some embodiments, the UE, utilizing c₀ and G_{centrum}, calculates the other cₖ values. Each cₖ, along with the secondary common basis U_{secondary} is used to form H, 0≤i≤K. The UE then computes the uplink precoding matrix and applies it on the uplink transmission.

In some embodiments, consider the reference sub-channel is the i-th sub-channel in the K+1 sub-channels (i=0, 1, . . . K), the UE may reconstruct the UL channel using the relations \tilde{y}ᵢ=U_{secondary}cᵢ₊ⱼ and cᵢ₊ⱼ=(G_{centrum})^{j}cᵢ, 0≤i+j≤K.

In some embodiments, if the K+1 sub-channels are numbered as 1, 2, . . . K+1, consider the reference sub-channel is the i-th sub-channel in the K+1 sub-channels (i=1, 2, . . . K+1), the UE may reconstruct the UL channel using the relations yᵢ=U_{secondary}cᵢ₊ⱼ and cᵢ₊ⱼ=(G_{centrum})^{j}cᵢ, 1≤i+j≤K+1.

In some embodiments, consider the UEs are clustered based on G_{y} and the cluster centrum is G_{y-centrum}, the UE may reconstruct the UL channel using the relations yᵢ=(G_{y-centrum})ⁱyᵢ, 0≤i+j≤K.

In some embodiments, consider the UEs are clustered based on G_{y} and the cluster centrum is G_{y-centrum}, if the K+1 sub-channels are numbered as 1, 2, . . . K+1, consider the reference sub-channel is the i-th sub-channel in the K+1 sub-channels (i=1, 2, . . . K+1), the UE may reconstruct the UL channel using the relations yᵢ=(G_{y-centrum})ⁱyᵢ, 1≤i+j≤K+1.

2510, UE performs uplink precoding.

The UE computes the uplink precoding matrix and applies it on the uplink transmission based on the reconstructed UL channel.

2511, UE transmits precoded UL data via PUSCH to UE.

UE may adopt reconstructed UL channel to precoding UL data and transmit precoded UL data to BS.

In some embodiments, if the base station senses or identifies that a UE is transitioning from one cluster to another, possibly due to movement or changing channel conditions, it sends a message via PDCCH informing the UE of the new secondary common basis and secondary reference signal placement scheme pertaining to the new cluster, along with the new G_{centrum}. Correspondingly, the UE acknowledges the receipt and understanding of the new secondary common basis and secondary reference signal placement scheme via PUCCH.

In the adaptive and scalable framework of the disclosed technology, a nuanced arrangement of a cluster within a cluster is envisaged, facilitating a layered structure of common bases for optimized channel estimation and resource allocation. Upon the establishment of clusters based on the primary common basis, a further subdivision within each cluster is performed to identify sub-clusters, each epitomizing a higher degree of commonality among the UEs therein. This subdivision engenders a third common basis, which is associated with the secondary common basis pertaining to the overarching cluster. The third common basis encapsulates a finer granularity of channel characteristics, thereby fostering a more precise channel estimation and reference signal placement scheme tailored to the sub-cluster. This nested clustering architecture, with a tertiary common basis nested within a secondary common basis, augments the adaptability and efficiency of the system, enabling a more judicious utilization of radio resources. The hierarchy of common bases, each corresponding to a distinct level of clustering, unveils a robust mechanism for navigating the intricate and dynamic radio environment, ensuring a steadfast performance even in the face of evolving channel conditions and UE distributions. Through the meticulous orchestration of common bases across multiple layers of clustering, the disclosed embodiment heralds a sophisticated, yet pragmatic, approach to managing the vast channel space and the multifarious propagation scenarios encountered in 6G T-MIMO systems.

Enhanced Channel Estimation: The procedure delineated in embodiments shown in FIG. 23 to FIG. 25 facilitates more precise channel estimation by clustering UEs based on their dynamic modes. This clustering engenders a more refined common basis and reference signal placement scheme for each cluster, enhancing the accuracy of channel estimation.

Reduced overhead: The segmentation of UEs into distinct clusters, each with its own secondary common basis and reference signal placement scheme, potentially curtails the overhead associated with reference signal transmission. Unlike in 5G NR UL-MIMO where a common set of reference signals is transmitted across the entire cellular coverage, this clustering approach allows for a tailored set of reference signals per cluster, thereby economizing on the radio resources.

Optimized resource utilization: The centrum dynamic mode proffered in this embodiment allows for a simplified communication between the base station and the UEs within a cluster, particularly during the uplink transmission phase. This simplification can lead to optimized utilization of uplink resources as compared to the 5G NR UL-MIMO which might not have such a streamlined process.

Adaptive cluster transition handling: The adaptive mechanism of transitioning UEs from one cluster to another as per their movement or changing channel conditions is a salient advantage. This dynamism ensures that UEs are always grouped with others that share similar channel characteristics, thereby maintaining the efficiency and accuracy of the channel estimation and uplink transmission processes.

Improved uplink precoding: The fine tuning state as illustrated in embodiments shown in FIG. 22 to FIG. 25 allow for a more refined uplink precoding mechanism. By utilizing the secondary common basis and the centrum dynamic mode, the UEs are able to compute the uplink precoding matrix with a higher resolution, even on a per-subcarrier basis, which is a marked improvement over the 5G NR UL-MIMO.

Scalable to environment variabilities: 6G T-MIMO system as delineated in this embodiment is designed to adapt to the environmental variabilities by constantly fine-tuning the common basis and reference signal placement schemes. This scalability ensures that the system remains efficient even in a time-varying radio environment with varying UE distributions and movements.

Enhanced uplink transmission: The methodology of utilizing a secondary common basis and a centrum dynamic mode for uplink transmission delineated in this embodiment fosters an enhanced uplink transmission. The provision for the UE to compute and apply the uplink precoding matrix based on the feedback from the base station engenders a more accurate and efficient uplink communication as compared to the 5G NR UL-MIMO.

This embodiment, with its meticulous design, addresses the challenges posed by the time-varying wireless environment and the larger cellular coverage of 6G T-MIMO, thereby presenting a substantial advancement over the existing 5G NR UL-MIMO technology.

The embodiments of this disclosure further provides a communication method.

FIG. 26 illustrates a flow diagram of a communication method according to some embodiments of the disclosure. As shown in FIG. 26, the method comprising: 2601, UE transmits K sets of SRSs corresponding to K sub-channels to BS.

UE may transmit K sets of SRSs corresponding to K sub-channels of UL channel to BS, K is positive integer.

In some embodiment, K=1, which means the UE may transmit a set of SRSs corresponding to the reference sub-channel to the BS while a G_{centrum} or G_{c-centrum} or G_{y-centrum} IS adopted. The detail may refers to the description of embodiments shown in FIG. 23 and FIG. 25.

In some embodiment, the UE may transmit multiple sets of SRSs corresponding to multiple sub-channels to the BS while a G_{centrum} or Go-centrum or G_{y-centrum} is adopted. In some embodiment, K>1, which means the UE may transmit K sets of SRSs corresponding to K sub-channels to the BS while G_{centrum} or G_{c-centrum} or G_{y-centrum} is not adopted. The detail may refers to the description of embodiments shown in FIG. 22 and FIG. 24.

In some embodiments, the UE may transmit the K sets of SRSs by broadcasting, multicasting or uncast ways.

In some embodiments, the UL channel may be segmented in to M (M≥K) sub-channels.

In some embodiments, the M sub-channels are equal-sized.

In some embodiments, sub-channel may also refer to unit in the description part.

In some embodiments, the M sub-channels are segmented based on one or more of following domain: frequency domain, time domain, space domain (e.g. antennas or antenna ports of the UE, or antennas or antenna ports of the BS). The detail ways of segmenting the UL channel may refers to the embodiments shown in FIG. 14A-14D.

In some embodiments, each set of SRSs is corresponding to one sub-channel in the K sub-channels.

In some embodiments, the K sub-channels are continues sub-channels.

In some embodiments, there are Q sub-channels between the n-th sub-channel in the K sub-channels and the (n+1)-th sub-channel in the K sub-channels, Q is positive integer. In those embodiments, the amount of SRS may be reduced (reduce Q times), which may reduce the communication resource and computation resource used for UL channel estimation. For example, consider that the UL channel is segmented into M sub-channels (SC₁, SC₂, . . . , SC_{M}), the K sub-channels may be SC₁, SC₅, SC₉, . . . , SC_{M-4}, the amount of SRSs is just quarter of the amount of the sub-channels of the UL channel, which may reduce at least 4 times of resource used for UL channel estimation. In detail, consider c₁, c₅, c₀, . . . , c_{M} are low-dimension coefficient vectors specifically corresponding to SC₁, SC₅, SC₉, . . . , SC_{M-4}, the BS may executes DMD to derive a dynamic mode G_{c} from c₁, c₅, c₀, . . . , c_{M} based on c_{HighUnits}=G_{c}c_{LowUnits}, wherein c_{LowUnits}={c₁, c₅, c₀, . . . , C_{M-4}} and c_{HighUnits}={c₅, c₉, . . . , c_{M}}.

2602, BS transmits DCI corresponding to the K sets of SRSs to the UE.

With the K sets of SRSs, BS may determine or detect DCI corresponding to the K sets of SRSs and transmit the DCI to the UE.

In some embodiments, considered K>1, the DCI may comprise a first information indicating the channel estimation for a reference sub-channel among the K sub-channels, and a second information indicating a transformation relationship between the channel estimation of the reference sub-channel and the channel estimation of other sub-channels within the K sub-channels other than the reference sub-channel.

In some embodiments, considered K=1, the DCI may comprise a first information indicating the channel estimation for the sub-channel (reference sub-channel).

In some embodiment, considered K>1 and G_{centrum} or G_{c-centrum} or G_{y-centrum} is adopted, the DCI may comprise a first information indicating the channel estimation for reference sub-channel with in the K sub-channels.

In some embodiment, considered K>1 and G_{centrum} or G_{c-centrum} or G_{y-centrum} is adopted, the BS may determine channel estimation of K sub-channels and perform DMD computation on channel estimation of K sub-channels to determine if the UE cluster that the UE belonging to has changed. If the UE cluster that the UE belonging to has changed to a new UE cluster, the BS may transmit (e.g. via DCI or other information) centrum G (e.g. G_{c-centrum} or G_{y-centrum}) of the new UE cluster to the UE. So that the UE may reconstruct its UL channel based on the centrum G of the new UE cluster.

In some embodiments, the first information may comprise channel coefficient vector of a reference sub-channel (yᵢ), while the second information comprising a first transformation matrix (G_{y}) or a first transformation information indicating the first transformation matrix, and the first transformation matrix indicates a relationship between the reference channel coefficient vector (yᵢ) and the channel coefficient vectors of sub-channels within the K sub-channels other than the first channel coefficient vector (yᵢ). In some embodiments, yᵢ₊ⱼ=G_{y}^{j}yᵢ, the reference sub-channel is the i-th sub-channel in the K sub-channels, yᵢ₊ⱼ refers to the channel coefficient vector of the (i+j)-th sub-channel in the K sub-channels, i and j are integer, 1≤i+j≤K.

In some embodiments, the first transformation information may comprises one or more matrices determined by decomposing the first transformation matrix. For example, the one or more matrices may comprise a first eigenvalue matrix (Ψ_{y}) and a first eigenvector matrix (Λ_{y}), where in the first eigenvalue matrix (y) and the first eigenvector matrix (Λ_{y}) are determined by performing Eigen-decomposition on the first transformation matrix (G_{y}). In those embodiments, the one or more matrices determined by decomposing the first transformation matrix may have smaller data amount than the first transformation matrix itself, which may reduce the communication resource needed for transmitting the first transformation matrix.

In some embodiments, the first information comprises a first low-dimension channel coefficient vector (cᵢ) corresponding to a first channel coefficient vector (yᵢ) of the reference sub-channel, while the second information comprises a second transformation matrix (G_{c}) or a second transformation information indicating the second transformation matrix, and the second transformation matrix indicates a relationship between the first low-dimension channel coefficient vector (cᵢ) and low-dimension channel coefficient vectors corresponding to the channel coefficient vectors of sub-channels within the K sub-channels other than the first low-dimension channel coefficient vector (cᵢ). In some embodiments, cᵢ₊ⱼ=G^{j}cᵢ, the reference sub-channel is the i-th sub-channel in the K sub-channels, cᵢ₊ⱼ refers to the low-dimension channel coefficient vector of the (i+j)-th sub-channel in the K sub-channels, 1≤i+j≤K, i and j are integer.

In some embodiments, the second transformation information comprises one or more matrices determined by decomposing the second transformation matrix. For example, the one or more matrices may comprise a second eigenvalue matrix (Ψ_{c}) and a second eigenvector matrix (Λ_{c}) wherein the second eigenvalue matrix (c) and the second eigenvector matrix (Λ_{c}) is determined by performing Eigen-decomposition on the second transformation matrix (G_{c}). In those embodiments, the one or more matrices determined by decomposing the second transformation matrix may have smaller data amount than the second transformation matrix itself, which may reduce the communication resource needed for transmitting the first transformation matrix.

In some embodiments, the method for determining the DCI may refer to the aforementioned step 2105, step 2106, step S14, step S24, step 2406 or step 2507.

In some embodiments, the UE may transmit other information for determine the DCI to the BS before transmit the K sets of SRSs. For example, the UE may transmit the aforementioned common basis U, secondary common basis U_{secondary}, the low-dimension matrix of the common basis U or U_{secondary} (such as the aforementioned P or information indicating P, aforementioned P_{secondary} or information indicating P_{secondary}), the centrum G (e.g G_{c-centrum} or G_{y-centrum}) of UE cluster comprising the UE.

In some embodiment, the BS may transmit G_{c} or G_{y} or G_{c-centrum} or G_{y-centrum} itself, or information indicating G_{c} or G_{y} or Go-centrum or G_{y-centrum}, such as one or more matrices determined by decomposing G_{c} or G_{y} or G_{c-centrum} or G_{y-centrum}. The detail may refers step 2107, step S15, step S22, step 2407, and step 2502.

In some embodiments, the second information may be determined by aforementioned DMD, DFT, FFT, DNN or other methods.

In some embodiments, the reference sub-channel refers to any sub-channel within the K sub-channels.

2603, UE reconstruct UL channel based on the DCI.

The UE may reconstruct UL channel based on the DCI. For example, the UE may determine the channel coefficient vectors of one or more sub-channels of UL channel.

For example, consider the K sub-channels are numbered as 1, 2, . . . K, the reference sub-channel is the i-th sub-channel in the K sub-channels, 0≤i≤K, the UE may reconstruct the UL channel based one of the following ways:
yᵢ₊ⱼ=G_{y}^{j}yᵢ, case received yᵢ and G_{y}, or information indicating yᵢ and G_{y};
yᵢ₊ⱼ=Ψ_{y}Λ_{y}^{j}Ψ_{y}⁻¹yᵢ, case received yᵢ, Ψ_{y} and Λ_{y}, or information indicating yᵢ, Ψ_{y} and Λ_{y};
yᵢ₊ⱼ=G_{y-centrum}^{j}yᵢ case received yᵢ and G_{y-centrum}, or information indicating yᵢ and G_{y}-centrum;
yᵢ₊ⱼ=Ψ_{y-centrum}Λ_{y-centrum}^{j}Ψ_{y-centrum}⁻¹yᵢ, case received yᵢ, Ψ_{y-centrum} and Λ_{y-centrum}, or information indicating yᵢ, Ψ_{y-centrum} and Λ_{y-centrum};
yᵢ₊ⱼ=UG_{c}^{j}cᵢ, case received cᵢ and Ge, or information indicating cᵢ and G_{c};
yᵢ₊ⱼ=UΨ_{c}Λ_{c}^{j}Ψ_{c}⁻¹cᵢ, case received cᵢ, Ψ_{c} and Λ_{c}, or information indicating cᵢ, Ψ_{c} and Λ_{c};
yᵢ₊ⱼ=U_{secondary}G^{j}cᵢ, case received cᵢ and Ge, or information indicating cᵢ and G_{c};
yᵢ₊ⱼ=U_{secondary}ΨΛ_{c}^{j}Ψ_{c}⁻¹cᵢ, case received cᵢ, L′e and Λ_{c}, or information indicating cᵢ, Ψ_{c} and Λ_{c};
yᵢ₊ⱼ=UG_{c-centrum}^{j}cᵢ, case received cᵢ or information indicating cᵢ;
yᵢ₊ⱼ=UΨ_{c-centrum}Λ_{c-centrum}^{j}Ψ_{c-centrum}⁻¹cᵢ, case received cᵢ, Ψ_{c-centrum} and Λ_{c-centrum}, or information indicating cᵢ, Ψ_{c-centrum} and Λ_{c-centrum};
yᵢ₊ⱼ=U_{secondary}G_{c-centrum}^{j}cᵢ, case received cᵢ or information indicating cᵢ;
yᵢ₊ⱼ=U_{secondary}Ψ_{c-centrum}Λ_{c}-centrum^{j}Ψ_{c-centrum}⁻¹cᵢ, case received cᵢ, Ψ_{c-centrum} and Λ_{c-centrum}, or information indicating cᵢ, Ψ_{c-centrum} and Λ_{c-centrum};
wherein, yᵢ₊ⱼ refers to channel coefficient vector of the (i+j)-th sub-channel in the K sub-channels, yᵢ refers to channel coefficient vector of the i-th sub-channel in the K sub-channels, cᵢ refers to low-dimension channel coefficient vector of the i-th sub-channel in the K sub-channels, U refers to a common basis of the UL channel, U_{secondary} refers to a secondary common basis corresponding a UE cluster, the UE cluster comprises the UE, G_{c-centrum} indicates a relationship between low-dimension channel coefficient vectors of sub-channels of each UE in the UE cluster, eigenvalue matrix Ψ_{y} and eigenvector matrix Λ_{y} are determined by performing Eigen-decomposition on G_{y}, eigenvalue matrix Ψ and eigenvector matrix Λ_{c} are determined by performing Eigen-decomposition on Ge, eigenvalue matrix Ψ_{c-centrum} and eigenvector matrix Λ_{c-centrum} are determined by performing Eigen-decomposition on Go-centrum, eigenvalue matrix Ψ_{y}-centrum and eigenvector matrix Λ_{y-centrum} are determined by performing Eigen-decomposition on G_{y-centrum}, i and j are integer, 1≤i+j≤K.

The detail of reconstructing the UL channel may refer to aforementioned step 2108, step S16, step S26, step 2408 or step 2509.

In some embodiments, Both of Hᵢ₊ⱼ and yᵢ₊ⱼ may indicating the channel estimation of the (i+j)-th sub-channel of the UL channel, which means Hᵢ₊ⱼ and yᵢ₊ⱼ are interchangeable in formulas mentioned in this disclosure. In some embodiments, Both of Hᵢ and yᵢ may indicating the channel estimation of the i-th sub-channel of the UL channel, which means Hᵢ and yᵢ are interchangeable in formulas mentioned in this disclosure.

With the method shown in FIG. 26, the BS and the UE may transmit less information for estimating the UL channel, which may decrease the resource used for channel estimation and improve communication efficiency.

An embodiment of this application further provides a computer-readable storage medium. The computer-readable storage medium stores computer instructions used to implement the method performed by the transmitting apparatus or the method performed by the receiving apparatus in the foregoing method embodiments.

For example, when the computer program is executed by a computer, the computer is enabled to implement the method performed by the transmitting apparatus or the method performed by the receiving apparatus in the foregoing method embodiments.

An embodiment of this application further provides a computer program product including instructions. When the instructions are executed by a computer, the computer is enabled to implement the method performed by the transmitting apparatus or the method performed by the receiving apparatus in the foregoing method embodiments.

An embodiment of this application further provides a communication system. The communication system includes the transmitting apparatus and the receiving apparatus in the foregoing embodiments.

For explanations and beneficial effects of related content of any communication apparatus provided above, refer to a corresponding method embodiment provided above. Details are not described herein again.

In some embodiments, at least parts of functions of UE or BS may be embedded into one or more chips or chipsets. The disclosure provides one or more chips or chipsets realizing at least parts of functions of UE or BS executing instructions or corresponding circuits.

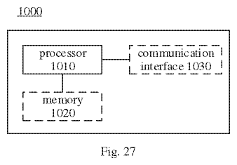

Illustratively, referring to FIG. 27, FIG. 27 shows a schematic block diagram of an apparatus according to some embodiments of this disclosure. The apparatus 1000 includes a processor 1010. The processor 1010 may be coupled to a memory 1020. The memory 1020 is configured to store a computer program or instructions and/or data. The processor 1010 is configured to execute the computer program or instructions and/or data stored in the memory 1020, so that the methods in the foregoing method embodiments are executed.

In some embodiments, the apparatus 1000 includes one or more processors 1010.

In some embodiments, as shown in FIG. 27, the apparatus 1000 may further include the memory 1020.

In some embodiments, the apparatus 1000 may include one or more memories 1020.

In some embodiments, the memory 1020 may be integrated with the processor 1010, or disposed separately from the processor 1010.

In some embodiments, as shown in FIG. 27, the apparatus 1000 may further include a communication interface 1030, and the communication interface 1030 is configured to communication with other apparatus/chips/device/chipset. For example, the processor 1010 is configured to receive a signal across a receiver or transmit a signal across a transmitter based on the communication interface 1030. For another example, the processor 1010 may store data to a memory or read data from a memory based on the communication interface 1030.

In some embodiments, the detail description of processor 1010 may refer to the aforementioned processor 210/260/276.

In some embodiments, the detail description of memory 1020 may refer to the aforementioned memory 208/258/278.

In some embodiments, the apparatus 1000 may comprise more modules.

In some embodiments, the apparatus 1000 may be applied as a BS or UE. And the apparatus 1000 may execute instructions to realize the steps executed by UE in FIG. 20 to FIG. 26, or execute instructions to realize the steps executed by BS in FIG. 20 to FIG. 26.

The processor mentioned in embodiments of this application may be a central processing unit (CPU), the processor may further be another general-purpose processor, a digital signal processor (DSP), an ASIC, a FPGA, or another programmable logic device, a discrete gate, a transistor logic device, a discrete hardware component, or the like. The general-purpose processor may be a microprocessor, or the processor may be any conventional processor or the like.

The memory mentioned in embodiments of this application may be a volatile memory or a non-volatile memory, or may include a volatile memory and a non-volatile memory. The non-volatile memory may be a ROM, a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (RAM). For example, the RAM may be used as an external cache. By way of example but not limitation, the RAM may include a plurality of forms in the following: a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM).

It should be noted that when the processor is a general-purpose processor, a DSP, an ASIC, an FPGA, another programmable logic device, a discrete gate or a transistor logic device, or a discrete hardware component, the memory (storage module) may be integrated into the processor.

It should be further noted that the memory described in this specification is intended to include, but is not limited to, these memories and any other memory of a suitable type.

A person of ordinary skill in the art may be aware that, in combination with the examples described in embodiments disclosed in this specification, units and methods may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the protection scope of this application.

It may be clearly understood by a person skilled in the art that, for the purpose of convenient and brief description, for a detailed working process of the foregoing apparatus and unit, refer to a corresponding process in the foregoing method embodiment. Details are not described herein again.

In the several embodiments provided in this application, the disclosed apparatuses and methods may be implemented in other manners. For example, the described apparatus embodiment is merely an example. For example, division into the units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic forms, mechanical forms, or other forms.

The units described as separate parts may or may not be physically separate, and parts displayed as units may or may not be physical units, may be located in one position, or may be distributed on a plurality of network units. Some or all of the units may be selected based on an actual requirement to implement the solutions provided in this application.

In some embodiments, “and/or” forms a list of elements inclusive alone or in any combination. For example, an example described as including A, B, and/or C may indicating at least one of A, B, C, such as: A or B or C alone; A and B; A and C; B and C; A, B and C.

In some embodiments, “/” indicating a relationship of “or”. For example, an example described as A/B which may indicating A or B.

In addition, function units in embodiments of this application may be integrated into one unit, or each of the units may exist alone physically, or two or more units are integrated into one unit. All or some of foregoing embodiments may be implemented by using software, hardware, firmware, or any combination thereof. When the software is used to implement embodiments, all or a part of embodiments may be implemented in a form of a computer program product. The computer program product includes one or more computer instructions. When the computer program instructions are loaded and executed on the computer, the procedures or functions according to embodiments of this application are all or partially generated. The computer may be a general-purpose computer, a special-purpose computer, a computer network, or another programmable apparatus. For example, the computer may be a personal computer, a server, a network device, or the like. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, and microwave, or the like) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, a solid state disk (SSD)), or the like. For example, the usable medium may include but is not limited to any medium that can store program code, such as a USB flash drive, a removable hard disk, a ROM, a RAM, a magnetic disk, or an optical disc.

The foregoing description is merely a specific implementation of this application, but is not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims and the specification.

The various options and embodiments described herein may be combined in different permutations. Also, although the application has been described with reference to specific features and embodiments thereof, various modifications and combinations can be made thereto without departing from the application. The description and drawings above are, accordingly, to be regarded simply as an illustration of some embodiments of the application, and are contemplated to cover any and all modifications, variations, combinations or equivalents.

### Definitions of Acronyms & Glossaries

LTE long term evolution
NR new radio
BS base station
CSI channel state information
CSI-RS channel state information reference signal
DCI downlink control information
DL downlink
gNB next generation (or 5g) base station
HARQ-ACK hybrid automatic repeat request acknowledgement
MAC medium access control
PDCCH physical downlink control channel
PDSCH physical downlink shared channel
PUCCH physical uplink control channel
PUSCH physical uplink shared channel
RB resource block
RE resource element
RRC radio resource control
SR scheduling request
SRS sounding reference signal
SSB synchronization signal block
UCI uplink control information
UE user equipment
UL uplink

What is claimed is:

1. A method, comprising:
receiving K sets of sounding reference signals corresponding to K sub-channels of an uplink (UL) channel, wherein K is a positive integer; and
transmitting a downlink control information (DCI) based on the K sets of sounding reference signals, wherein the DCI comprises a first information indicating a channel estimation of a first sub-channel among the K sub-channels.

2. The method according to claim 1, wherein:
K is greater than 1; and
the DCI further comprises a second information indicating a relationship between the channel estimation of the first sub-channel and a channel estimation of one or more sub-channels within the K sub-channels other than the first sub-channel.

3. The method according to claim 2, wherein:
the K sub-channels are equal-sized.

4. The method according to claim 2, wherein:
the K sets of sounding reference signals are respectively corresponding to the K sub-channels, and
each set of the K sets of sounding reference signals are transmitted on the corresponding sub-channel.

5. The method according to claim 2, wherein:
the first information comprises a first channel coefficient vector (yᵢ) of the first sub-channel;
the second information comprises a first transformation matrix (G_{y}) or a first transformation information indicating the first transformation matrix; and
the first transformation matrix indicates a relationship between the first channel coefficient vector (yᵢ) and channel coefficient vectors of one or more sub-channels within the K sub-channels other than the first channel coefficient vector (yᵢ).

6. A method, comprising:
transmitting K sets of sounding reference signals corresponding to K sub-channels of an uplink (UL) channel, wherein K is a positive integer; and
receiving a downlink control information (DCI) corresponding to the K sets of sounding reference signals, wherein the DCI comprises a first information indicating a channel estimation of a first sub-channel among the K sub-channels.

7. The method according to claim 6, wherein K is greater than 1, and the DCI further comprises a second information indicating a relationship between the channel estimation of the first sub-channel and a channel estimation of one or more sub-channels within the K sub-channels other than the first sub-channel.

8. The method according to claim 7, wherein the method further comprises:
reconstructing the UL channel based on the DCI.

9. The method according to claim 7, wherein:
the K sub-channels are equal-sized.

10. The method according to claim 7, wherein:
the K sets of sounding reference signals are respectively corresponding to the K sub-channels, and
each set of the K sets of sounding reference signals are transmitted on the corresponding sub-channel.

11. An apparatus, comprising:
at least one processor and at least one memory coupled to the at least one processor, the at least one memory storing one or more instructions that, when executed by the at least one processor, cause the apparatus to:
receive K sets of sounding reference signals corresponding to K sub-channels of an uplink (UL) channel, wherein K is a positive integer; and
transmit a downlink control information (DCI) based on the K sets of sounding reference signals, wherein the DCI comprises a first information indicating a channel estimation of a first sub-channel among the K sub-channels.

12. The apparatus according to claim 11, wherein K is greater than 1, and the DCI further comprises a second information indicating a relationship between the channel estimation of the first sub-channel and a channel estimation of one or more sub-channels within the K sub-channels other than the first sub-channel.

13. The apparatus according to claim 12, wherein the K sub-channels are equal-sized.

14. The apparatus according to claim 12, wherein the K sets of sounding reference signals are respectively corresponding to the K sub-channels, and each set of the K sets of sounding reference signals are transmitted on the corresponding sub-channel.

15. The apparatus according to claim 12, wherein the first information comprises a first channel coefficient vector (yᵢ) of the first sub-channel, the second information comprises a first transformation matrix (G_{y}) or a first transformation information indicating the first transformation matrix, and the first transformation matrix indicates a relationship between the first channel coefficient vector (yᵢ) and channel coefficient vectors of one or more sub-channels within the K sub-channels other than the first channel coefficient vector (yᵢ).

16. An apparatus, comprising:
at least one processor and at least one memory coupled to the at least one processor, the at least one memory storing one or more instructions that, when executed by the at least one processor, cause the apparatus to:
transmit K sets of sounding reference signals corresponding to K sub-channels of an uplink (UL) channel, wherein K is a positive integer; and
receiving a downlink control information (DCI) corresponding to the K sets of sounding reference signals, wherein the DCI comprises a first information indicating a channel estimation of a first sub-channel among the K sub-channels.

17. The apparatus according to claim 16, wherein K is greater than 1, and the DCI further comprises a second information indicating a relationship between the channel estimation of the first sub-channel and a channel estimation of one or more sub-channels within the K sub-channels other than the first sub-channel.

18. The apparatus according to claim 17, wherein when the one or more instructions, when executed by the at least one processor, further cause the apparatus to reconstruct the UL channel based on the DCI.

19. The apparatus according to claim 17, wherein the K sub-channels are equal-sized.

20. The apparatus according to claim 17, wherein the K sets of sounding reference signals are respectively corresponding to the K sub-channels, and each set of the K sets of sounding reference signals are transmitted on the corresponding sub-channel.
